(19) United States
(12) Patent Application Publication
(10) Pub. No.: US 2025/0284163 A1
(43) Pub. Date: Sep. 11, 2025

(54) DISPLAY DEVICE

(71) Applicant: Sharp Display Technology Corporation, Kameyama City (JP)

(72) Inventor: Yohsuke FUJIKAWA, Kameyama City (JP)

(21) Appl. No.: 19/063,137

(22) Filed: Feb. 25, 2025

(30) Foreign Application Priority Data
Mar. 7, 2024 (JP) 2024-034657

(51) Int. Cl. G02F 1/1362; G02F 1/1345

(52) U.S. Cl. CPC G02F 1/136286; G02F 1/13452

(57) ABSTRACT

A display device includes: a display panel including a display region and a non-display region; a driver; a control terminal portion connected to the driver; a first circuit portion interposed between the display region and the driver; and a control wiring line connected to each of the control terminal portion and the first circuit portion. A side portion closest to the display region of an outer peripheral portion of the driver is taken as a first side portion. The first circuit portion extends from a center side toward an end side in a first direction along the first side portion in the non-display region and includes a first end portion located at the center side in the first direction in the non-display region. The control wiring line is arranged extending from the control terminal portion to the first end portion across the first side portion.

### CROSS-REFERENCE TO RELATED APPLICATIONS

This application claims the benefit of priority to Japanese Patent Application Number 2024-034657 filed on Mar. 7, 2024. The entire contents of the above-identified application are hereby incorporated by reference.

### BACKGROUND

### Technical Field

Techniques disclosed in the present specification relate to display devices in which a load on control wiring lines is lessened and a frame is made narrower.

As examples of display devices in the related art, the display devices described in JP 2002-350893 A, WO 2014/013945, and WO 2007/026446 are known. In a liquid crystal display device as the display device described in JP 2002-350893 A, input signal wiring lines of a built-in integrated circuit formed of low-temperature polycrystalline silicon TFTs are disposed in a region of an IC that is mounted by COG on the liquid crystal display device, so that lead-out electrode terminals for the low-temperature polycrystalline silicon integrated circuit are disposed on both sides of lead-out electrode terminals for the IC to narrow a non-display region necessary for the lead-out electrode terminals.

A liquid crystal display device as the display device described in WO 2014/013945 includes: a liquid crystal panel having a display portion and a non-display portion; a driver formed in a rectangular shape extending along a side portion of the liquid crystal panel; a panel-side output terminal portion connected to the driver; a plurality of image signal wiring lines that are extended from the panel-side output terminal portion across a long side of the driver and drawn while spreading in a fan shape toward the display portion and transmit image signals; a plurality of control signal wiring lines that are drawn from the panel-side output terminal portion toward the display portion and transmit control signals; a first control signal wiring line that is drawn toward the display portion following the image signal wiring lines; and a second control signal wiring line that is extended from the panel-side output terminal portion across a short side of the driver, and has a line width that is at least partially wider than that of the first control signal wiring line.

A liquid crystal panel as the display device described in WO 2007/026446 has a structure in which two substrates are bonded, and includes: an element-side substrate provided with a base substrate, a pixel array formed of display elements disposed in a two-dimensional form on the base substrate, and a control circuit that is disposed on the base substrate along a side of the pixel array and controls the display elements row by row or column by column; and a counter substrate facing the element-side substrate. The control circuit is configured such that unit control circuits each corresponding to a control unit of the display elements are continuously disposed in a one-dimensional form. A disposition interval of the unit control circuits is narrower than that of the control units of the display elements, and a difference between the disposition interval of the unit control circuits and the disposition interval of the control units is equal to or smaller than a minimum wiring line width or minimum wiring line interval acceptable by the control circuits.

### SUMMARY

In JP 2002-350893 A, the input signal wiring lines are routed across the IC region, extending from the lead-out electrode terminals for the low-temperature polycrystalline silicon integrated circuit to the built-in integrated circuit. Because of this, the wiring line length of the input signal wiring lines is likely to be long, and there arises a concern that the load on the input signal wiring lines increases.

In WO 2014/013945, the first control signal wiring line that is drawn from the panel-side output terminal portion toward the display portion following the image signal wiring lines is connected to an end portion of a column control circuit portion extending along a long side direction of the driver. Since this first control signal wiring line is arranged to be closer to the end side than the image signal wiring line located at the endmost position among the plurality of image signal wiring lines, the wiring line length of the first control signal wiring line is likely to be long, and there arises a concern that the load on the first control signal wiring line increases. In addition, it is necessary to secure a disposition space for the first control signal wiring line in the vicinity of the end portion in the long side direction of the driver in the non-display portion, whereby there arises a concern that the frame of the liquid crystal panel is widened.

In WO 2007/026446, wiring lines drawn from external terminals are connected to an end portion in the extending direction of a column control circuit having a horizontally long shape. In other words, the wiring lines described in WO 2007/026446 are configured in the same manner as the first control signal wiring line described in WO 2014/013945, and the wiring line length of the wiring lines is likely to be long, whereby there arises a concern that the load on the wiring lines increases.

The techniques described herein have been developed based on the circumstances described above, and an object thereof is to lessen the load on the control wiring lines and to make the frame narrower.

(1) A display device related to the techniques described herein includes: a display panel including a main surface including a display region in which an image is displayed and a non-display region surrounding the display region; a driver attached to the non-display region; a control terminal portion provided at a position overlapping the driver in the non-display region and connected to the driver; a first circuit portion arranged to be interposed between the display region and the driver in the non-display region; and a control wiring line provided in the non-display region, connected to each of the control terminal portion and the first circuit portion, and configured to transmit a control signal for controlling operations of the first circuit portion. A planar shape of the driver takes a rectangular shape, and a side portion closest to the display region of an outer peripheral portion of the driver is taken as a first side portion. The first circuit portion extends from a center side toward an end side in a first direction along the first side portion in the non-display region and includes at least a first end portion located at the center side in the first direction in the non-display region. The control wiring line is arranged extending from the control terminal portion to the first end portion of the first circuit portion across the first side portion.

(2) In addition to (1) described above, the display device may further include: a first terminal portion provided at a position overlapping the driver in the non-display region; and a second terminal portion provided at a position overlapping the driver in the non-display region. The first terminal portion may be arranged closer to the center side in the first direction than the control terminal portion in the non-display region, the second terminal portion may be arranged being distanced from the first terminal portion with a space on the center side of the first terminal portion in the first direction in the non-display region, and the control wiring line may be arranged in such a manner as to pass through between the first terminal portion and the second terminal portion and cross the first side portion.

(3) In addition to (2) described above, the display device may further include: a signal wiring line arranged in the display region and extending in a second direction intersecting the first direction; a signal terminal portion provided at a position overlapping the driver in the non-display region and connected to the driver; and a signal connection wiring line provided in the non-display region, connected to the signal terminal portion and the signal wiring line, and configured to transmit a signal to be supplied to the signal wiring line. The signal terminal portion may be located between the control terminal portion and the first terminal portion in the first direction, and a plurality of the signal terminal portions may be arranged side by side at intervals in the first direction.

(4) In addition to (2) described above, the display device may further include: a signal wiring line arranged in the display region and extending in a second direction intersecting the first direction; a signal terminal portion provided at a position overlapping the driver in the non-display region and connected to the driver; and a signal connection wiring line provided in the non-display region, connected to the signal terminal portion and the signal wiring line, and configured to transmit a signal to be supplied to the signal wiring line. A plurality of the signal terminal portions may be arranged side by side at intervals in the first direction. The first terminal portion, the second terminal portion, and the signal terminal portion may be arranged in a row along the first direction. The control terminal portion may be arranged to be located on an opposite side to a display region side in the second direction with respect to the first terminal portion, the second terminal portion, and the signal terminal portion.

(5) The display device may be such that, in addition to any one of (2) to (4) described above, the first terminal portion and the second terminal portion may be each a dummy terminal portion that is electrically isolated.

(6) In addition to (1), the display device may further include a third terminal portion provided at a position overlapping the driver in the non-display region, wherein the control terminal portion may be arranged to be located on a display region side with respect to the third terminal portion in a second direction intersecting the first direction.

(7) In addition to any one of (1) to (6) described above, the display device may further include: a first signal wiring line arranged in the display region and extending along the second direction intersecting the first direction; a second signal wiring line arranged in the display region and extending along the second direction; and a signal connection wiring line arranged in the non-display region and configured to transmit a signal to be supplied to a plurality of the signal wiring lines. The control terminal portion includes a first control terminal portion and a second control terminal portion. The control wiring line includes a first control wiring line connected to the first control terminal portion and a second control wiring line connected to the second control terminal portion. The first circuit portion includes a first switching element connected to the first signal wiring line, the signal connection wiring line and the first control wiring line, and a second switching element connected to the second signal wiring line, the signal connection wiring line, and the second control wiring line.

(8) The display device is such that, in addition to any one of (1) to (7) described above, the display panel may include a variable outer shape portion whose external dimension in the first direction changes depending on a position in the second direction intersecting the first direction, and the first circuit portion may extend following the outer shape of the variable outer shape portion.

According to the technique described herein, it is possible to lessen the load on the control wiring lines and make the frame narrower.

### BRIEF DESCRIPTION OF DRAWINGS

The disclosure will be described with reference to the accompanying drawings, wherein like numbers reference like elements.

FIG. 1 is a plan view of a liquid crystal panel, a driver, and a flexible substrate according to a first embodiment.

FIG. 2 is a cross-sectional view of the liquid crystal panel, the driver, and the flexible substrate according to the first embodiment.

FIG. 3 is a plan view illustrating a pixel arrangement of the liquid crystal panel according to the first embodiment.

FIG. 4 is a plan view illustrating a configuration in the vicinity of an exposed portion of an array substrate constituting the liquid crystal panel according to the first embodiment.

FIG. 5 is a bottom view of the driver according to the first embodiment.

FIG. 6 is a cross-sectional view illustrating a connection state between an output terminal of the array substrate and an output bump of the driver according to the first embodiment.

FIG. 7 is a plan view illustrating a mounting region of the driver and a configuration of a switch circuit in the array substrate according to the first embodiment.

FIG. 8 is a plan view illustrating a configuration of a mounting region of a driver in an array substrate according to a second embodiment.

FIG. 9 is a plan view illustrating a liquid crystal panel, a driver, and a flexible substrate according to a third embodiment.

FIG. 10 is a plan view illustrating a configuration of a mounting region of the driver in an array substrate according to the third embodiment.

FIG. 11 is a bottom view of the driver according to the third embodiment.

FIG. 12 is a plan view illustrating a configuration of a mounting region of a driver in an array substrate according to a fourth embodiment and depicting a case in which a switch control wiring line is connected to a switch control terminal portion constituting a first group.

FIG. 13 is a plan view illustrating the configuration of the mounting region of the driver in the array substrate according to the fourth embodiment and depicting a case in which a switch control wiring line is connected to a switch control terminal portion constituting a second group.

FIG. 14 is a plan view of a liquid crystal panel, a driver, and a flexible substrate according to a fifth embodiment.

FIG. 15 is a plan view illustrating a configuration of a mounting region of the driver in an array substrate according to the fifth embodiment.

### DESCRIPTION OF EMBODIMENTS

### First Embodiment

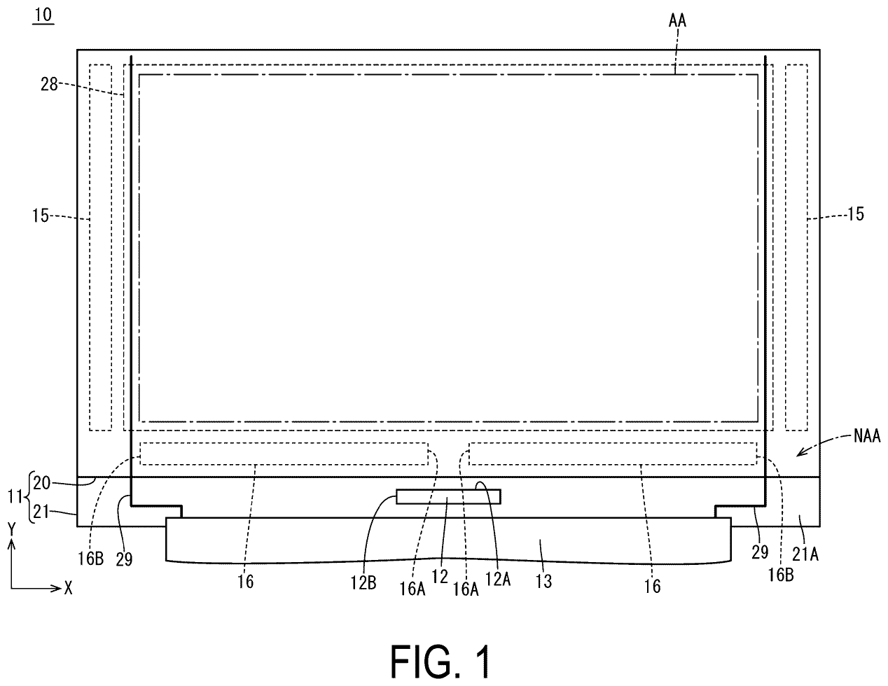

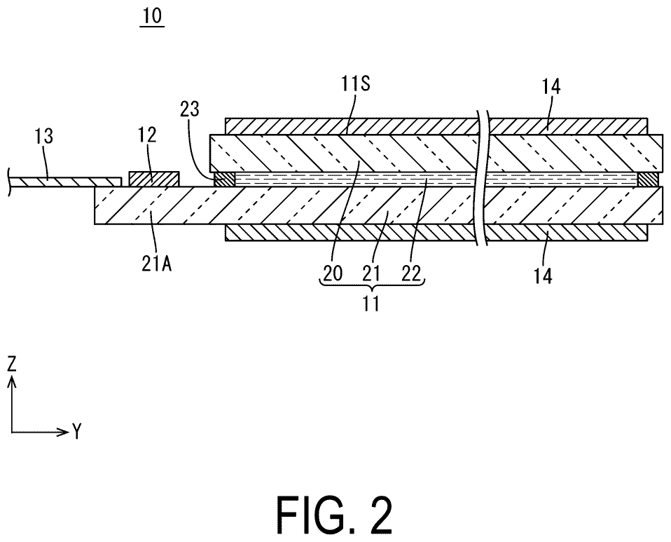

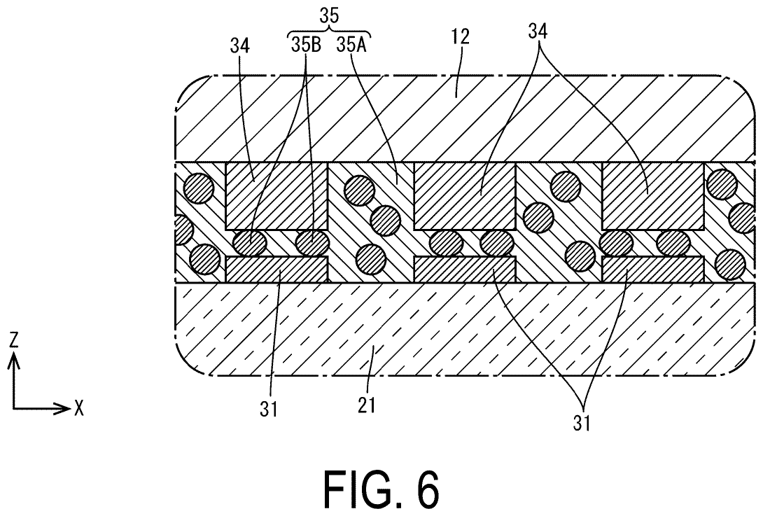

A first embodiment will be described with reference to FIG. 1 to FIG. 7. In the present embodiment, a liquid crystal display device (a display device) 10 is described. Note that some drawings illustrate an X-axis, a Y-axis, and a Z-axis, and directions of these axes are drawn so as to be common in all the drawings. An upper side and a lower side in FIG. 2 and FIG. 6 are defined as a front side and a rear side, respectively.

The liquid crystal display device 10, as illustrated in FIG. 1, includes at least a liquid crystal panel (display panel) 11, which has a horizontally elongated rectangular shape and is capable of displaying an image, and a backlight device (illumination device) that irradiates the liquid crystal panel 11 with light for use in display. The backlight device includes a light source (for example, an LED or the like) disposed on a rear side (back face side) of the liquid crystal panel 11 and configured to emit light having a white color, an optical member configured to impart an optical effect on the light from the light source, thereby converting the light into planar light, and the like. A center-side portion of a main surface 11S of the liquid crystal panel 11 is a display region AA, in which an image is displayed. In contrast, a frame-shaped outer peripheral side portion surrounding the display region AA in the main surface 11S of the liquid crystal panel 11 is a non-display region NAA, in which no image is displayed.

The liquid crystal panel 11 will be described with reference to FIG. 2 in addition to FIG. 1. As illustrated in FIGS. 1 and 2, the liquid crystal panel 11 is formed by bonding a pair of substrates 20 and 21 together. Of the pair of substrates 20 and 21, the substrate on a front side is a counter substrate 20, and the substrate on a rear side is an array substrate 21. The counter substrate 20 and the array substrate 21 are each formed by layering various films on an inner face side of a glass substrate. A liquid crystal layer 22 is interposed between the pair of substrates 20 and 21 and contains liquid crystal molecules, which are substances having optical characteristics that change in accordance with application of an electrical field. A sealing portion 23 configured to seal the liquid crystal layer 22 is provided to be interposed between outer peripheral end portions of the pair of substrates 20 and 21. The sealing portion 23 is formed in a rectangular frame-like shape to surround the liquid crystal layer 22. Note that polarizers 14 are bonded to outer face sides of both the substrates 20 and 21, respectively.

As illustrated in FIG. 1 and FIG. 2, the counter substrate 20 has a short side dimension shorter than a short side dimension of the array substrate 21. The counter substrate 20 is bonded to the array substrate 21 with one end portion in a short side direction (Y-axis direction) aligned with one end portion of the array substrate 21. Thus, the other end portion of the array substrate 21 in the short side direction is an exposed portion 21A, which protrudes laterally relative to the counter substrate 20 and is exposed. An overall region of this exposed portion 21A is the non-display region NAA, in which a driver 12 for supplying various signals and a flexible substrate 13 are mounted.

As illustrated in FIGS. 1 and 2, the driver 12 is mounted on the exposed portion 21A of the array substrate 21 by Chip On Glass (COG). The driver 12 includes an LSI chip having a drive circuit therein. The driver 12 processes various signals transmitted by the flexible substrate 13. The driver 12 is arranged adjacent to one side of the display region AA in the Y-axis direction in the exposed portion 21A and is disposed being interposed between the flexible substrate 13 to be described below and the display region AA. One driver 12 is arranged in the vicinity of a central position in the X-axis direction of the exposed portion 21A. The driver 12 has a horizontally elongated rectangular planar shape. The driver 12 has a long side dimension smaller than a long side dimension of the display region AA. An outer peripheral portion constituting the outer shape of the driver 12 includes a pair of long side portions and a pair of short side portions. Of the pair of long side portions of the driver 12, a long side portion closer to the display region AA is defined as a first side portion 12A closest to the display region AA in the outer peripheral portion. Each of the pair of short side portions of the driver 12 is continuous with the first side portion 12A, and one (left side in FIG. 1) of the pair of short side portions is defined as a second side portion 12B. The first side portion 12A is parallel to the X-axis direction (first direction). The second side portion 12B is parallel to the Y-axis direction (a second direction intersecting the first direction).

The flexible substrate 13 has a configuration in which a large number of wiring line patterns are formed on a base material made of a synthetic resin material (for example, a polyimide resin or the like) having insulating properties and flexibility. As illustrated in FIG. 1 and FIG. 2, one end side of the flexible substrate 13 is connected to the exposed portion 21A of the array substrate 21, and the other end side thereof is connected to an external circuit substrate (control substrate, or the like). The flexible substrate 13 is connected to an end portion of the exposed portion 21A on a side opposite to the display region AA side in the Y-axis direction with respect to the driver 12. That is, the flexible substrate 13 is attached to the exposed portion 21A at a position where the driver 12 is interposed between the flexible substrate 13 and the display region AA.

As illustrated in FIG. 1, gate drive circuits 15 and switch circuits (first circuit portions) 16 are provided in the non-display region NAA of the array substrate 21. A pair of gate drive circuits 15 is provided to sandwich the display region AA from both sides thereof in the X-axis direction. The gate drive circuits 15 are each provided in a vertically elongate belt-shaped range extending along a short side direction (Y-axis direction) of the array substrate 21. The gate drive circuit 15 is a circuit for supplying a scanning signal to a gate wiring line 26 to be described later and is provided monolithically on the array substrate 21.

As illustrated in FIG. 1, the switch circuit 16 is arranged in the non-display region NAA at a position interposed between the display region AA and the driver 12 in the Y-axis direction. The switch circuits 16 are each provided in a horizontally long belt-shaped range extending along a long side direction (X-axis direction) of the array substrate 21. A pair of switch circuits 16 is arranged side by side at an interval in the X-axis direction. One end portion of the switch circuit 16 in its extending direction (X-axis direction) is referred to as a first end portion 16A located on the center side in the X-axis direction in the non-display region NAA. The other end portion of the switch circuit 16 in its extending direction is referred to as a second end portion 16B located on the end side in the X-axis direction in the non-display region NAA. The switch circuit 16 is a so-called Source Shared Driving (SSD) circuit, having a switching function of distributing image signals supplied from the driver 12 to source wiring lines 27 to be described later. A specific circuit configuration of the switch circuit 16 and the like will be described later in detail.

A common electrode 28 is provided to the display region AA and the non-display region NAA of the array substrate 21, as illustrated in FIG. 1. The common electrode 28 is arranged in a solid manner over the entire display region AA, and an outer peripheral end portion thereof is arranged in the non-display region NAA. Common wiring lines 29 connected to the common electrode 28 are arranged in the non-display region NAA of the array substrate 21. A pair of the common wiring lines 29 is arranged to sandwich the display region AA from both sides thereof in the X-axis direction and is disposed to overlap both end portions of the common electrode 28 in the X-axis direction. The common electrode 28 will be described in detail later.

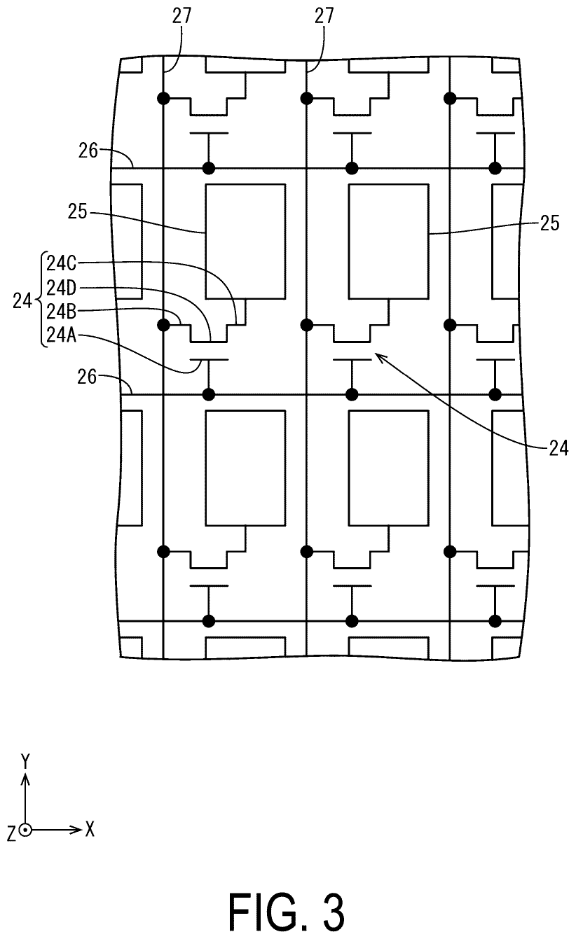

Next, a configuration of the display region AA in the array substrate 21 will be described with reference to FIG. 3. As illustrated in FIG. 3, at least a TFT (thin film transistor, switching element) 24 and a pixel electrode 25 are provided on an inner face side of the display region AA of the array substrate 21. A plurality of the TFTs 24 and a plurality of the pixel electrodes 25 are provided in a matrix shape at intervals therebetween along the X-axis direction and the Y-axis direction. The gate wiring lines (scanning wiring lines) 26 and the source wiring lines (signal wiring lines, image wiring lines) 27 orthogonal to (intersecting with) each other are disposed around the TFTs 24 and the pixel electrodes 25. The gate wiring lines 26 extend along the X-axis direction and a plurality of the gate wiring lines 26 are arranged at intervals in the Y-axis direction. The source wiring lines 27 extend along the Y-axis direction and a plurality of the source wiring lines 27 are arranged at intervals in the X-axis direction. The gate wiring line 26 is formed of part of a first metal film. The source wiring line 27 is formed of part of a second metal film arranged on the upper-layer side of the first metal film via a gate insulating film. The gate wiring line 26 and the source wiring line 27 intersecting with each other are kept in an insulated state by the gate insulating film interposed therebetween. The first metal film and the second metal film are both single-layer films made of one type of metal material, or layered films or alloys made of different types of metal materials, and thus have electrical conductivity. As a material of the first metal film and the second metal film, for example, tantalum, molybdenum, titanium, or aluminum is used. The gate insulating film is made of an inorganic material such as silicon nitride (SiNₓ) or silicon oxide (SiO₂).

As illustrated in FIG. 3, the TFT 24 includes a gate electrode 24A connected to the gate wiring line 26, a source electrode 24B connected to the source wiring line 27, a drain electrode 24C connected to the pixel electrode 25, and a semiconductor portion 24D connected to the source electrode 24B and drain electrode 24C and made of a semiconductor material. The gate electrode 24A is made of part of the first metal film. Each of the source and drain electrodes 24B and 24C is made of part of the second metal film. The semiconductor portion 24D is composed of part of a semiconductor film located on the lower-layer side of the second metal film on the upper-layer side of the gate insulating film. The semiconductor film is made of a polycrystalline polysilicon semiconductor material, an oxide semiconductor material, or the like. The TFT 24 is driven on the basis of a scanning signal supplied to the gate electrode 24A by the gate wiring line 26. Then, a potential of an image signal (data signal) supplied from the driver 12 to the source electrode 24B through the source wiring line 27 is supplied to the drain electrode 24C through the semiconductor portion 24D. As a result, the pixel electrode 25 is charged to the potential related to the image signal.

As illustrated in FIG. 3, the pixel electrode 25 is arranged in a region surrounded by the gate wiring lines 26 and the source wiring lines 27, and a planar shape thereof takes a substantially rectangular shape, for example. The pixel electrode 25 is formed of part of a first transparent electrode film arranged on the upper-layer side of the second metal film constituting the drain electrode 24C via one or two insulating films. The first transparent electrode film is made of a transparent electrode material (e.g., Indium Tin Oxide (ITO) or Indium Zinc Oxide (IZO)). When one insulating film is interposed between the second metal film and the first transparent electrode film, the one insulating film is made of an organic material such as PMMA (acrylic resin). When two insulating films are interposed between the second metal film and the first transparent electrode film, the insulating film on the lower-layer side of the two insulating films is made of, for example, the same inorganic material as the gate insulating film, and the insulating film on the upper-layer side thereof is made of, for example, an organic material such as PMMA (acrylic resin). The pixel electrode 25 overlaps with a color filter disposed in the display region AA of the counter substrate 20 and constitutes a pixel together with the color filter. The color filters exhibit three colors of red (R), green (G), and blue (B), for example. In the liquid crystal panel 11, the R, G, and B color filters aligned along the X-axis direction and three pixel electrodes 25 respectively facing the color filters constitute subpixels of three colors. The subpixels of three colors constitute one display pixel capable of color display.

The common electrode 28 depicted in FIG. 1 overlaps all the pixel electrodes 25 arranged in the display region AA. A slit is formed on a portion of the common electrode 28 overlapping each pixel electrode 25. The common electrode 28 is formed of part of a second transparent electrode film arranged on the upper-layer side of the first transparent electrode film constituting the pixel electrode 25 via an insulating film. The second transparent electrode film is made of the same transparent electrode material as the first transparent electrode film. The insulating film interposed between the first transparent electrode film and the second transparent electrode film is made of the same inorganic material as the gate insulating film. A common potential (reference potential) is supplied to the common electrode 28 by the common wiring lines 29. When the pixel electrode 25 is charged to a potential based on an image signal transmitted to the source wiring line 27 in association with the driving of the TFT 24, a potential difference is generated between the pixel electrode 25 and the common electrode 28. Then, a fringe electrical field including a component in a normal direction with respect to a main surface of the array substrate 21 in addition to a component along the main surface of the array substrate 21 is generated between an opening edge of the slit in the common electrode 28 and the pixel electrode 25. Thus, it is possible to control the alignment state of the liquid crystal molecules included in the liquid crystal layer 22 by using this fringe electrical field, and a predetermined display is performed based on the alignment state of the liquid crystal molecules. That is, an operation mode of the liquid crystal panel 11 according to this embodiment is a Fringe Field Switching (FFS) mode. Note that alignment films for aligning the liquid crystal molecules included in the liquid crystal layer 22 are respectively provided on innermost faces of both of the substrates 20 and 21.

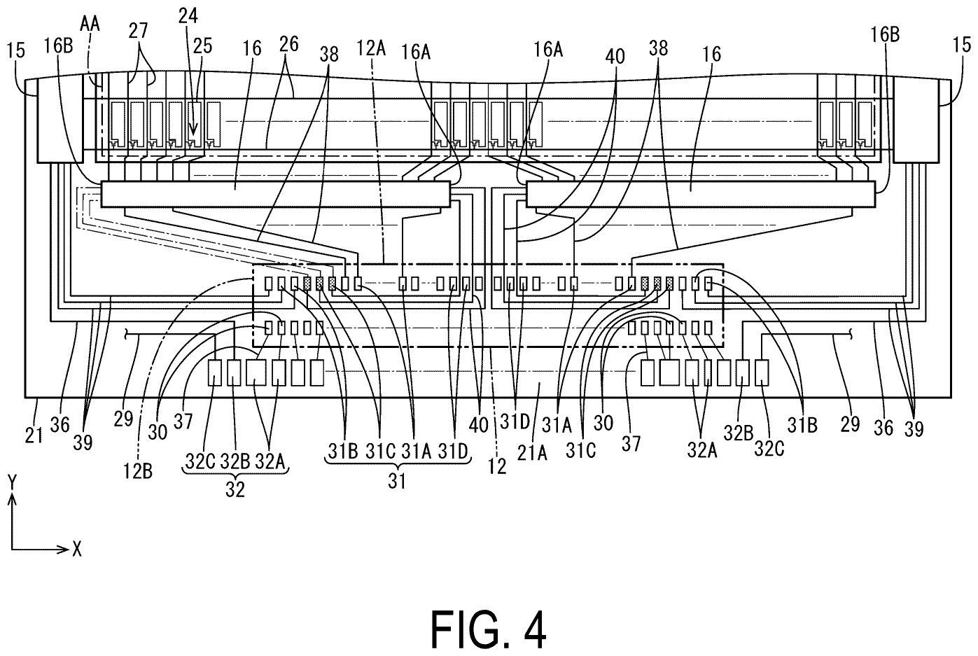

As illustrated in FIG. 4, wiring lines and terminals for supplying various signals (potentials) to the gate wiring lines 26, the source wiring lines 27, and the like are provided on the inner face side of the exposed portion 21A, which is the non-display region NAA of the array substrate 21. A plurality of terminal portions 30 and 31 are provided in a disposition region (mounting region) of the driver 12 overlapping in a plan view with the driver 12 in the exposed portion 21A. The plurality of terminal portions 30 and 31 are arranged overlapping the driver 12 mounted on the exposed portion 21A and are connected to the driver 12. In addition, a plurality of terminal portions 32 for a flexible substrate are provided in a disposition region of the flexible substrate 13 in the exposed portion 21A. The terminal portion 30, the terminal portion 31, and the terminal portion 32 for the flexible substrate are each formed using the first metal film, the second metal film or the like, and the uppermost layer thereof is covered with a transparent electrode formed of the first transparent electrode film, the second transparent electrode film, or the like. The plurality of terminal portions 32 for the flexible substrate are arranged overlapping the flexible substrate 13 to be mounted and are connected to the flexible substrate 13. The plurality of terminal portions 32 for the flexible substrate are arranged side by side at intervals to form a row along the X-axis direction, and each planar shape takes a vertically elongated rectangular shape. The terminal portion 32 for the flexible substrate is larger in size and area in a plan view than each of the terminal portions 30 and 31 arranged in the disposition region of the driver 12. The plurality of terminal portions 32 for the flexible substrate include terminal portions 32A for the driver supplied with signals for driving the driver 12 by the flexible substrate 13, power supply terminal portions 32B supplied with a power supply voltage for driving the gate drive circuits 15 by the flexible substrate 13, and common potential terminal portions 32C, to which a common potential to be supplied to the common electrode 28 is supplied by the flexible substrate 13. In the non-display region NAA of the array substrate 21, power source wiring lines 36 connected to the power supply terminal portions 32B and the gate drive circuits 15 are provided. The power source wiring line 36 is formed using the first metal film, the second metal film, or the like. The common wiring lines 29 are connected to the common potential terminal portions 32C. Note that in FIG. 4, an outer shape of the driver 12 to be mounted on the exposed portion 21A is indicated by a two-dotted-dashed line.

As illustrated in FIG. 4, the plurality of terminal portions 30 and 31 arranged in the disposition region of the driver 12 include a plurality of input terminal portions 30 for inputting signals to the driver 12 and a plurality of output terminal portions 31 for receiving output of signals from the driver 12. The input terminal portion 30 and the output terminal portion 31 each have a vertically elongated rectangular planar shape and are each arranged in such a manner that the long sides are parallel to the Y-axis direction and the short sides are parallel to the X-axis direction. The number of output terminal portions 31 is larger than the number of input terminal portions 30. The signals output from the driver 12 to the output terminal portions 31 include an image signal, a switch signal (control signal), a clock signal, an initialization signal, a gate start pulse signal, and the like.

As illustrated in FIG. 4, the input terminal portions 30 are located on a side farther from the display region AA (the first side portion 12A of the driver 12) in the Y-axis direction than the output terminal portions 31. Specifically, the input terminal portions 30 are each arranged at a position close to a side portion that is farthest from the display region AA in the outer peripheral portion of the driver 12 in the Y-axis direction. The plurality of input terminal portions 30 form one row along the X-axis direction and are linearly arranged side by side at intervals along the X-axis direction. That is, the plurality of input terminal portions 30 are aligned in such a manner that both end positions thereof in the Y-axis direction are substantially the same. The plurality of input terminal portions 30 are individually connected to the plurality of terminal portions 32 for the flexible substrate arranged at intervals in the Y-axis direction, via inter-terminal connection wiring lines 37. The inter-terminal connection wiring line 37 is arranged across the mounting region of the driver 12 and the mounting region of the flexible substrate 13 in the non-display region NAA of the array substrate 21. The inter-terminal connection wiring line 37 is formed using the first metal film, the second metal film, or the like.

As illustrated in FIG. 4, the output terminal portions 31 are located on a side closer to the display region AA (the first side portion 12A of the driver 12) in the Y-axis direction than the input terminal portions 30. Specifically, the output terminal portions 31 are each arranged at a position close to the first side portion 12A, which is closest to the display region AA in the outer peripheral portion of the driver 12 in the Y-axis direction. The plurality of output terminal portions 31 form one row along the X-axis direction and are linearly arranged side by side at intervals along the X-axis direction. That is, the plurality of output terminal portions 31 are aligned in such a manner that both end positions thereof in the Y-axis direction are substantially the same. Types of the plurality of output terminal portions 31 will be described in detail later.

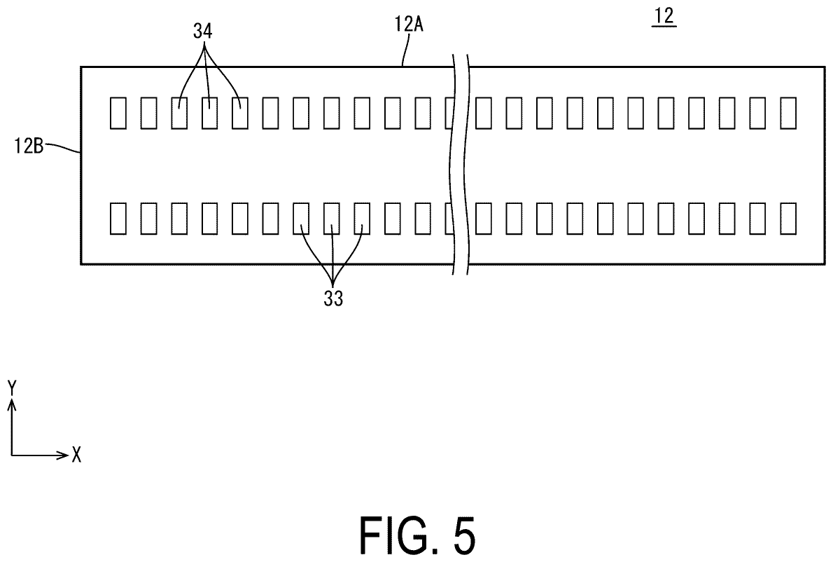

As illustrated in FIG. 5, a plurality of bumps 33 and 34 to be connected to the plurality of terminal portions 30 and 31 are provided on a main surface (bottom face, rear face) of the driver 12 facing the array substrate 21. The bumps 33 and 34 are provided to protrude in the Z-axis direction from the main surface of the driver 12 toward the array substrate 21 side. The bumps 33 and 34 are connected to a circuit provided inside the driver 12. On the main surface of the driver 12, the plurality of bumps 33 and 34 are arranged side by side at the positions overlapping the terminal portions 30 and 31 on the array substrate 21 side. The plurality of bumps 33 and 34 include a plurality of input bumps 33 for receiving input of signals from the array substrate 21 and a plurality of output bumps 34 for outputting signals to the array substrate 21. Each of the input bumps 33 and the output bumps 34 has a vertically elongated rectangular planar shape and is arranged in such a manner that the long sides are parallel to the Y-axis direction and the short sides are parallel to the X-axis direction.

As illustrated in FIG. 5, the input bumps 33 are located on a side farther from the first side portion 12A (the display region AA) of the driver 12 in the Y-axis direction than the output bumps 34. The plurality of input bumps 33 form one row along the X-axis direction and are linearly arranged side by side at intervals along the X-axis direction. That is, the plurality of input bumps 33 are aligned in such a manner that both end positions thereof in the Y-axis direction are substantially the same. When the driver 12 is attached to the array substrate 21, the plurality of input bumps 33 are arranged at the positions overlapping the plurality of input terminal portions 30 in a plan view and connected to the plurality of overlapping input terminal portions 30.

As illustrated in FIG. 5, the output bumps 34 are located on a side closer to the first side portion 12A (the display region AA) of the driver 12 in the Y-axis direction than the input bumps 33. The plurality of output bumps 34 form one row along the X-axis direction and are linearly arranged side by side at intervals along the X-axis direction. That is, the plurality of output bumps 34 are aligned in such a manner that both end positions thereof in the Y-axis direction are substantially the same. When the driver 12 is attached to the array substrate 21, the plurality of output bumps 34 are arranged at the positions overlapping the plurality of output terminal portions 31 in a plan view and connected to the plurality of overlapping output terminal portions 31.

As illustrated in FIG. 6, the terminal portions 30 and 31 of the array substrate 21 and the bumps 33 and 34 of the driver 12 are connected to each other via an anisotropic conductive film (ACF) 35. FIG. 6 representatively illustrates a connection structure of the output terminal portions 31 and the output bumps 34, as well as a connection structure of the input terminal portions 30 and the input bumps 33. The anisotropic conductive film 35 will be described below. The anisotropic conductive film 35 is formed by dispersing and blending a large number of conductive particles 35B in a binder 35A including a thermosetting resin material. When mounting the driver 12, the anisotropic conductive film 35 and the driver 12 are set in the disposition region of the driver 12 on the array substrate 21, and in this state, the driver 12 is subjected to thermocompression bonding by applying a load toward the array substrate 21 side. As a result, the terminal portions 30 and 31 on the array substrate 21 side and the bumps 33 and 34 on the driver 12 side are electrically connected via the conductive particles 35B. Further, the binder 35A is thermally cured to mechanically fix the driver 12 to the array substrate 21.

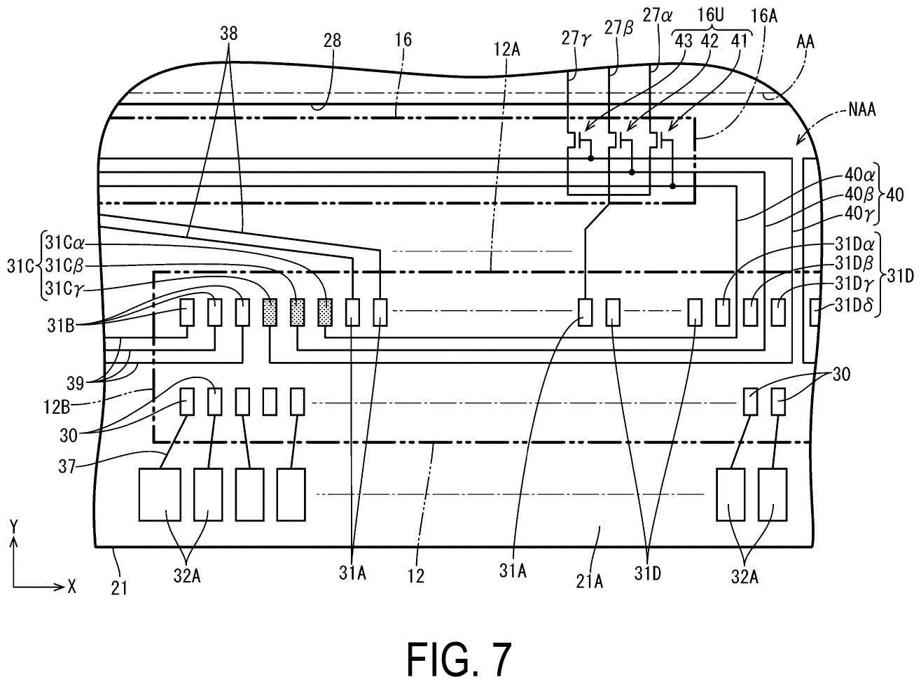

As illustrated in FIGS. 4 and 7, the plurality of output terminal portions 31 include signal terminal portions 31A supplied with image signals by the driver 12, gate control terminal portions 31B supplied with various signals for controlling the gate drive circuit 15 by the driver 12, switch control terminal portions (control terminal portions) 31C supplied with switch signals (control signals) for controlling the switch circuit 16 by the driver 12, and dummy terminal portions 31D. In FIGS. 4 and 7, the switch control terminal portions 31C are depicted in a shaded manner in order to distinguish them from the other terminal portions 30, 31A, 31B, and 31D. The driver 12 supplies a clock signal, an initialization signal, a gate start pulse signal, and the like to the gate control terminal portions 31B. Signal connection wiring lines 38 connected to the signal terminal portions 31A and the switch circuit 16, gate control wiring line 39 connected to the gate control terminal portions 31B and the gate drive circuit 15, and switch control wiring lines (control wiring lines) 40 connected to the switch control terminal portions 31C and the switch circuit 16 are provided in the non-display region NAA of the array substrate 21. Each of the wiring lines 38 to 40 is formed using the first metal film, the second metal film, or the like. The dummy terminal portions 31D are not connected to any wiring line and are electrically isolated from other wiring lines and terminal portions.

As illustrated in FIG. 4, a plurality of the signal terminal portions 31A, a plurality of the gate control terminal portions 31B, a plurality of the switch control terminal portions 31C, and a plurality of the dummy terminal portions 31D are disposed symmetrically in the mounting region of the driver 12. Similarly, a plurality of the signal connection wiring lines 38, a plurality of the gate control wiring lines 39, and a plurality of the switch control wiring lines 40 are disposed symmetrically in the non-display region NAA. The plurality of signal connection wiring lines 38 connected to the plurality of signal terminal portions 31A arranged approximately in the left half region of the mounting region of the driver 12 in FIG. 4 are connected to the plurality of source wiring lines 27 arranged approximately in the left half region of the display region AA in FIG. 4. The plurality of signal connection wiring lines 38 connected to the plurality of signal terminal portions 31A arranged approximately in the right half region of the mounting region of the driver 12 in FIG. 4 are connected to the plurality of source wiring lines 27 arranged approximately in the right half region of the display region AA in FIG. 4. The plurality of gate control wiring lines 39 connected to the plurality of gate control terminal portions 31B arranged approximately in the left half region of the mounting region of the driver 12 in FIG. 4 are connected to the gate drive circuit 15 arranged at the left side in FIG. 4 of the pair of gate drive circuits 15. The plurality of gate control wiring lines 39 connected to the plurality of gate control terminal portions 31B arranged approximately in the right half region of the mounting region of the driver 12 in FIG. 4 are connected to the gate drive circuit 15 arranged at the right side in FIG. 4 of the pair of gate drive circuits 15. In FIG. 7, the terminal portions 31A to 31D arranged approximately in the left half region of the mounting region of the driver 12 in FIG. 4 and the wiring lines 38 to 40 connected to the above terminal portions 31A to 31D are depicted as representatives.

A detailed configuration of the switch circuit 16 will be described below using FIG. 7. As illustrated in FIG. 7, the switch circuit 16 includes a plurality of unit switch circuit portions 16U arranged along the extending direction (X-axis direction) thereof. The number of unit switch circuit portions 16U is one third the number of source wiring lines 27. The unit switch circuit portion 16U includes three switch TFTs 41 to 43 connected to the switch control wiring lines 40, the signal connection wiring lines 38, and the source wiring lines 27 and configured to control the supply of the image signals. Three switch control wiring lines 40 are arranged at intervals in the Y-axis direction and all of them extend along the X-axis direction in a formation range of the switch circuit 16. The three switch control wiring lines 40 are a first switch control wiring line (first control wiring line, red switch control wiring line) 40α, a second switch control wiring line (second control wiring line, green switch control wiring line) 40β, and a third switch control wiring line (third control wiring line, blue switch control wiring line) 40γ in order from the lower side of FIG. 7. The signal connection wiring line 38 is branched into three portions in the formation range of the switch circuit 16, and each branched portion is disposed in such a manner as to intersect each switch control wiring line 40. The three switch TFTs 41 to 43 are, in order from the right side in FIG. 7, a first switch TFT (first switching element, red switch TFT) 41, a second switch TFT (second switching element, green switch TFT) 42, and a third switch TFT (blue switch TFT) 43. In the first switch TFT 41, the gate electrode is connected to the first switch control wiring line 40α, and the drain electrode is connected to a first source wiring line (first signal wiring line) 27α configured to supply an image signal to the pixel electrode 25 constituting a subpixel configured to exhibit a red color. In the second switch TFT 42, the gate electrode is connected to the second switch control wiring line 40B, and the drain electrode is connected to a second source wiring line (second signal wiring line) 27β configured to supply an image signal to the pixel electrode 25 constituting a subpixel configured to exhibit a green color. In the third switch TFT 43, the gate electrode is connected to the third switch control wiring line 40γ, and the drain electrode is connected to a third source wiring line (third signal wiring line) 27γ configured to supply an image signal to the pixel electrode 25 constituting a subpixel configured to exhibit a blue color. The source electrodes of the switch TFTs 41 to 43 are each connected to the three branched portions of the signal connection wiring line 38. The number of signal connection wiring lines 38 is one third the number of source wiring lines 27. By doing so, the number of wiring lines (signal connection wiring lines 38) existing between the driver 12 and the switch circuit 16 can be reduced to one third, compared to a case where the source wiring lines are directly connected to the driver 12. This allows the signal connection wiring lines 38 to be easily routed even when the frame of the liquid crystal panel 11 becomes narrower.

A first image signal (red image signal) for a subpixel to exhibit a red color, a second image signal (green image signal) for a subpixel to exhibit a green color, and a third image signal (blue image signal) for a subpixel to exhibit a blue color are supplied to the signal connection wiring lines 38 from the driver 12 in a time-division manner. In synchronization with this, a switch signal is supplied from the driver 12 to the three switch control wiring lines 40. Specifically, at a timing when the first image signal is supplied from the driver 12 to the signal connection wiring line 38, a switch signal is supplied from the driver 12 to the first switch control wiring line 40α. Thus, the first switch TFT 41 among the three switch TFTs 41 to 43 is selectively turned on, so that the first image signal can be supplied to the pixel electrode 25 constituting a subpixel configured to exhibit a red color via the selected first source wiring line 27α. At a timing when the second image signal is supplied from the driver 12 to the signal connection wiring line 38, a switch signal is supplied from the driver 12 to the second switch control wiring line 40β. Thus, the second switch TFT 42 among the three switch TFTs 41 to 43 is selectively turned on, so that the second image signal can be supplied to the pixel electrode 25 constituting a subpixel configured to exhibit a green color via the selected second source wiring line 27β. At a timing when the third image signal is supplied from the driver 12 to the signal connection wiring line 38, a switch signal is supplied from the driver 12 to the third switch control wiring line 40γ. Thus, the third switch TFT 43 among the three switch TFTs 41 to 43 is selectively turned on, so that the third image signal can be supplied to the pixel electrode 25 constituting a subpixel configured to exhibit a blue color via the selected third source wiring line 27γ. As described above, the switch circuit 16 can perform switching on the source wiring line 27 connected to the signal connection wiring line 38, in synchronization with the timing when the image signal is supplied from the driver 12 to the signal connection wiring line 38.

Next, the disposition of the terminal portions 31A to 31D in the mounting region of the driver 12 will be described. As illustrated in FIG. 7, the gate control terminal portions 31B are disposed at the endmost side (left side in FIG. 7) in the X-axis direction of the mounting region of the driver 12 in the non-display region NAA. Three gate control terminal portions 31B are arranged side by side at intervals in the X-axis direction. The switch control terminal portions 31C are disposed to be located closer to the center side (right side in FIG. 7) than the gate control terminal portions 31B in the X-axis direction in the non-display region NAA. Three switch control terminal portions 31C are arranged side by side at intervals in the X-axis direction. The signal terminal portions 31A are disposed to be located closer to the center side than the switch control terminal portions 31C in the X-axis direction in the non-display region NAA. The number of signal terminal portions 31A is about one third the number of source wiring lines 27, and the signal terminal portions 31A are arranged side by side at intervals in the X-axis direction. The dummy terminal portions 31D are disposed at the center-most side in the X-axis direction of the non-display region NAA, in the mounting region of the driver 12. The number of dummy terminal portions 31D is obtained by subtracting the numbers of signal terminal portions 31A, gate control terminal portions 31B, and switch control terminal portions 31C from the number of output bumps 34 of the driver 12 to be mounted, and the dummy terminal portions 31D are arranged side by side at intervals in the X-axis direction.

As illustrated in FIG. 7, in the non-display region NAA, the plurality of signal connection wiring lines 38 connected to the plurality of signal terminal portions 31A are extended from the mounting region of the driver 12 toward the display region AA. Here, the driver 12 has a long side dimension smaller than the short side dimension of the display region AA (see FIG. 1 and FIG. 4). Thus, the plurality of signal connection wiring lines 38 are routed to spread in a fan shape from the driver 12 side toward the display region AA side. Specifically, the plurality of signal connection wiring lines 38 extend from the signal terminal portions 31A as connecting targets toward the display region AA side (upper side in FIG. 7) along the Y-axis direction, cross the first side portion 12A of the driver 12 and then bend, and extend toward the source wiring lines 27 as connecting targets along a direction oblique to the X-axis direction and the Y-axis direction. As illustrated in FIG. 4, three gate control wiring lines 39 to be connected to the three gate control terminal portions 31B extend from the gate control terminal portions 31B as connecting targets along the Y-axis direction toward a side opposite to the display region AA side (the lower side in FIG. 4), bend and extend along the X-axis direction toward an end side of the non-display region NAA, bend and extend along the Y-axis direction toward the gate drive circuit 15 as a connecting target.

As illustrated in FIG. 7, the three switch control terminal portions 31C include a first switch control terminal portion (first control terminal portion) 31Cα connected to the first switch control wiring line 40α, a second switch control terminal portion (second control terminal portion) 31Cβ connected to the second switch control wiring line 40β, and a third switch control terminal portion (third control terminal portion) 31Cγ connected to the third switch control wiring line 40γ. At a timing when the first image signal is supplied from the driver 12 to the signal connection wiring line 38, a switch signal is supplied from the driver 12 to the first switch control terminal portion 31Cα. At a timing when the second image signal is supplied from the driver 12 to the signal connection wiring line 38, a switch signal is supplied from the driver 12 to the second switch control terminal portion 31Cβ. At a timing when the third image signal is supplied from the driver 12 to the signal connection wiring line 38, a switch signal is supplied from the driver 12 to the third switch control terminal portion 31Cγ.

As illustrated in FIG. 7, the three switch control wiring lines 40 extend from the switch control terminal portions 31C as connecting targets along the Y-axis direction toward the opposite side to the display region AA side, bend and extend along the X-axis direction toward the center side of the non-display region NAA (right side in FIG. 7) and then bend and extend along the Y-axis direction toward the display region AA side to cross the first side portion 12A of the driver 12. The three switch control wiring lines 40 bend after crossing the first side portion 12A of the driver 12, extend toward the end side (left side in FIG. 7) in the non-display region NAA along the X-axis direction, and are connected to the first end portion 16A of the switch circuit 16. The switch control wiring lines 40 are each arranged to pass through between the dummy terminal portions 31D arranged side by side along the X-axis direction in the mounting region of the driver 12 in the extending process from the switch control terminal portions 31C to the first end portion 16A of the switch circuit 16. Specifically, the first switch control wiring line 40α passes through between a first dummy terminal portion (first terminal portion) 31Dα and a second dummy terminal portion (second terminal portion) 31Dβ arranged side by side along the X-axis direction in the mounting region of the driver 12. The first dummy terminal portion 31Dα is arranged closer to the center side in the X-axis direction in the non-display region NAA than any of the switch control terminal portions 31C. The second dummy terminal portion 31Dβ is arranged spaced apart from the first dummy terminal portion 31Dα on the center side in the X-axis direction in the non-display region NAA. The second switch control wiring line 40β passes through between the second dummy terminal portion 31Dβ and a third dummy terminal portion 31Dγ arranged side by side along the X-axis direction in the mounting region of the driver 12. The third switch control wiring line 40γ passes through between the third dummy terminal portion 31Dγ and a fourth dummy terminal portion 31Dδ arranged side by side along the X-axis direction in the mounting region of the driver 12. An interval between two dummy terminal portions 31D adjacent to each other in the X-axis direction is sufficiently wider than the line width of the switch control wiring line 40.

As described above, the switch control wiring lines 40 according to the present embodiment are arranged in such a manner as to extend from the switch control terminal portions 31C to the first end portion 16A of the switch circuit 16 across the first side portion 12A of the driver 12. Therefore, as compared with a known case where a switch control wiring line is arranged to extend from the switch control terminal portion 31C to the second end portion (end-side portion in the X-axis direction in the non-display region NAA) 16B of the switch circuit 16 (see the switch control wiring line indicated by a chain line in FIG. 7), the wiring line length of the switch control wiring line 40 can be shortened and it is not needed to secure a disposition space of the switch control wiring line 40 in the vicinity of the end portion in the X-axis direction in the non-display region NAA. As a result, the load on the switch control wiring line 40 can be reduced, and the frame can be narrowed. In addition, the switch control wiring line 40 is arranged in such a manner as to pass through between the first dummy terminal portion 31Dα and the second dummy terminal portion 31Dβ and cross the first side portion 12A. Although the switch control terminal portion 31C is arranged closer to the end side in the X-axis direction in the non-display region NAA than the first dummy terminal portion 31Dα and the second dummy terminal portion 31Dβ, the switch control wiring line 40 connected to the switch control terminal portion 31C passes through between the first dummy terminal portion 31Dα and the second dummy terminal portion 31Dβ, thereby making it possible to reach the first end portion 16A of the switch circuit 16 while crossing the first side portion 12A. In addition, since the first dummy terminal portion 31Dα and the second dummy terminal portion 31Dβ are each electrically isolated, even when the switch control wiring line 40 is short-circuited with the first dummy terminal portion 31Dα or the second dummy terminal portion 31Dβ due to a manufacturing problem, the occurrence of an electrical problem can be prevented.

As illustrated in FIG. 7, the signal terminal portion 31A according to the present embodiment is located between the switch control terminal portions 31C and the first dummy terminal portion 31Dα in the X-axis direction, and the plurality of signal terminal portions 31A are arranged side by side at intervals in the X-axis direction. As described above, the switch control terminal portions 31C are located closer to the end side than the signal terminal portion 31A located at the endmost position in the X-axis direction in the non-display region NAA among the plurality of signal terminal portions 31A. Therefore, as compared with the known case where the switch control wiring line is arranged to extend from the switch control terminal portion 31C to the second end portion 16B of the switch circuit 16, it is not needed to secure a disposition space of the switch control wiring line 40 on the end side relative to the signal connection wiring lines 38 in the X-axis direction in the non-display region NAA. This configuration is suitable in making the frame narrower.

As discussed above, the liquid crystal display device (display device) 10 of the present embodiment includes: the liquid crystal panel (display panel) 11 including the main surface 11S including the display region AA, in which an image is displayed, and the non-display region NAA surrounding the display region AA; the driver 12 attached to the non-display region NAA; the switch control terminal portion (control terminal portion) 31C provided at a position overlapping the driver 12 in the non-display region NAA and connected to the driver 12; the switch circuit (first circuit portion) 16 arranged to be interposed between the display region AA and the driver 12 in the non-display region NAA; and the switch control wiring line (control wiring line) 40, which is provided in the non-display region NAA, connected to each of the switch control terminal portion 31C and the switch circuit 16, and configured to transmit a switch signal (control signal) for controlling operations of the switch circuit 16. A planar shape of the driver 12 takes a rectangular shape, and a side portion closest to the display region AA of an outer peripheral portion of the driver 12 is taken as the first side portion 12A. The switch circuit 16 extends from the center side toward an end side in a first direction along the first side portion 12A in the non-display region NAA and includes at least the first end portion 16A located at the center side in the first direction in the non-display region NAA. The switch control wiring line 40 is arranged extending from the switch control terminal portion 31C to the first end portion 16A of the switch circuit 16 across the first side portion 12A.

The switch control terminal portion 31C arranged at a position overlapping the driver 12 in the non-display region NAA of the liquid crystal panel 11 is connected to the driver 12 and is supplied with a switch signal from the driver 12. The switch signal supplied from the driver 12 is transmitted from the switch control terminal portion 31C and supplied to the switch circuit 16 through the switch control wiring line 40. The operations of the switch circuit 16 are controlled based on the switch signal supplied through the switch control wiring line 40.

Here, the switch circuit 16 extends from the center side toward the end side in the first direction along the first side portion 12A of the driver 12 in the non-display region NAA and has at least the first end portion 16A located on the center side in the first direction in the non-display region NAA. In contrast, the switch control wiring line 40 is arranged in such a manner as to extend from the switch control terminal portion 31C to the first end portion 16A of the switch circuit 16 across the first side portion 12A. Therefore, as compared with a known case where the switch control wiring line is arranged to extend from the switch control terminal portion 31C to the end-side portion in the first direction in the non-display region NAA of the switch circuit 16, the wiring line length of the switch control wiring line 40 can be shortened and it is not needed to secure a disposition space of the switch control wiring line 40 in the vicinity of the end portion in the first direction in the non-display region NAA. As a result, the load on the switch control wiring line 40 can be reduced, and the frame can be narrowed. In the present embodiment, the switch circuit 16 is divided to form a pair of circuits and arranged to be spaced apart from each other in the X-axis direction, and the switch control wiring line 40 occupies the resulting empty region, but the disclosure is not limited thereto. For example, the distance between the pair of switch circuits 16 may be minimized so that the first end portion 16A of one switch circuit 16 and the first end portion 16A of the other switch circuit 16 are close to or in contact with each other. In addition, the switch control wiring line 40 passing through the region of the one switch circuit 16 and the switch control wiring line 40 passing through the region of the other switch circuit 16 may be connected and shared, and the one switch circuit 16 and the other switch circuit 16 may be integrated. That is, the “first end portion” described in the present specification is not questioned whether or not an end portion corresponding to the first end portion 16A is clearly recognized as a region occupied by the switch circuit 16 in a plan view, and the “first end portion” indicates a position where a connection point between the switch circuit 16 and the switch control wiring line 40 is set. Accordingly, the “first end portion” in the present specification can be rephrased as a “connection point between the switch circuit (first circuit portion) and the control wiring line”. Further, as for the “control wiring line” described in the present specification, wiring line materials may differ before and after the connection point on the wiring line path, and the wiring lines before and after the connection point may be connected via a contact hole. Further, the “control wiring line” described in the present specification may be made of the same wiring line material before and after the connection point on the wiring line path.

Further, there are included: the first dummy terminal portion (first terminal portion) 31Dα provided at a position overlapping the driver 12 in the non-display region NAA; and a second dummy terminal portion (second terminal portion) 31Dβ provided at a position overlapping the driver 12 in the non-display region NAA. The first dummy terminal portion 31Dα is arranged closer to the center side in the first direction than the switch control terminal portion 31C in the non-display region NAA, the second dummy terminal portion 31Dβ is arranged spaced apart from the first dummy terminal portion 31Dα at the center side in the first direction in the non-display region NAA, and the switch control wiring line 40 is arranged in such a manner as to pass through between the first dummy terminal portion 31Dα and the second dummy terminal portion 31Dβ and cross the first side portion 12A. Although the switch control terminal portion 31C is arranged closer to the end side in the first direction in the non-display region NAA than the first dummy terminal portion 31Dα and the second dummy terminal portion 31Dβ, the switch control wiring line 40 connected to the switch control terminal portion 31C passes through between the first dummy terminal portion 31Dα and the second dummy terminal portion 31Dβ, thereby reaching the first end portion 16A of the switch circuit 16 while crossing the first side portion 12A.

Further, there are included: the source wiring line (signal wiring line) 27 arranged in the display region AA and extending in the second direction intersecting the first direction; the signal terminal portion 31A provided at a position overlapping the driver 12 in the non-display region NAA and connected to the driver 12; and the signal connection wiring line 38 provided in the non-display region NAA, connected to the signal terminal portion 31A and the source wiring line 27, and configured to transmit a signal to be supplied to the source wiring line 27. The signal terminal portion 31A is located between the switch control terminal portion 31C and the first dummy terminal portion 31Dα in the first direction, and the plurality of signal terminal portions 31A are arranged side by side at intervals in the first direction. The signal terminal portion 31A arranged at a position overlapping the driver 12 in the non-display region NAA of the liquid crystal panel 11 is connected to the driver 12 and is supplied with a signal from the driver 12. The signal supplied from the driver 12 is transmitted from the signal terminal portion 31A through the signal connection wiring line 38 and supplied to the source wiring line 27 in the display region AA. The switch control terminal portions 31C are located closer to the end side than the signal terminal portion 31A located at the endmost position in the first direction in the non-display region NAA among the plurality of signal terminal portions 31A. Therefore, as compared with a known case where the switch control wiring line is arranged to extend from the switch control terminal portion 31C to the end-side portion in the first direction in the non-display region NAA of the switch circuit 16, it is not needed to secure a disposition space of the switch control wiring line 40 on the end side relative to the signal connection wiring line 38 in the first direction in the non-display region NAA. This configuration is suitable in making the frame narrower.

The first dummy terminal portion 31Dα and the second dummy terminal portion 31Dβ are each referred to as the electrically isolated dummy terminal portion 31D. Even when the switch control wiring line 40 passing through between the first dummy terminal portion 31Dα and the second dummy terminal portion 31Dβ is short-circuited with the first dummy terminal portion 31Dα or the second dummy terminal portion 31Dβ due to a manufacturing problem, the occurrence of an electrical problem can be prevented because the first dummy terminal portion 31Dα and the second dummy terminal portion 31Dβ are each the electrically isolated dummy terminal portion 31D.

Further, there are included: the first source wiring line (first signal wiring line) 27α arranged in the display region AA and extending along the second direction intersecting the first direction; the second source wiring line (second signal wiring line) 27β arranged in the display region AA and extending along the second direction; and the signal connection wiring line 38 arranged in the non-display region NAA and configured to transmit a signal to be supplied to the plurality of source wiring lines 27. The switch control terminal portion 31C includes the first switch control terminal portion (first control terminal portion) 31Cα and the second switch control terminal portion (second control terminal portion) 31Cβ. The switch control wiring line 40 includes the first switch control wiring line (first control wiring line) 40 connected to the first switch control terminal portion 31Cα, and the second switch control wiring line (second control wiring line) 40β connected to the second switch control terminal portion 31Cβ. The switch circuit 16 includes the first switch TFT (first switching element) 41 connected to the first source wiring line 27α, the signal connection wiring line 38, and the first switch control wiring line 40α, and the second switch TFT (second switching element) 42 connected to the second source wiring line 27β, the signal connection wiring line 38, and the second switch control wiring line 40β. The first switch TFT 41 included in the switch circuit 16 is driven as the switch signal is supplied from the first switch control terminal portion 31Cα via the first switch control wiring line 40α and supplies the signal transmitted through the signal connection wiring line 38 to the first source wiring line 27α. The second switch TFT 42 included in the switch circuit 16 is driven as the switch signal is supplied from the second switch control terminal portion 31Cβ via the second switch control wiring line 40β and supplies the signal transmitted through the signal connection wiring line 38 to the second source wiring line 27β. In other words, the switch circuit 16 functions to distribute the signal transmitted through the signal connection wiring line 38 to each source wiring line 27 based on the switch signal transmitted through each switch control wiring line 40.

### Second Embodiment

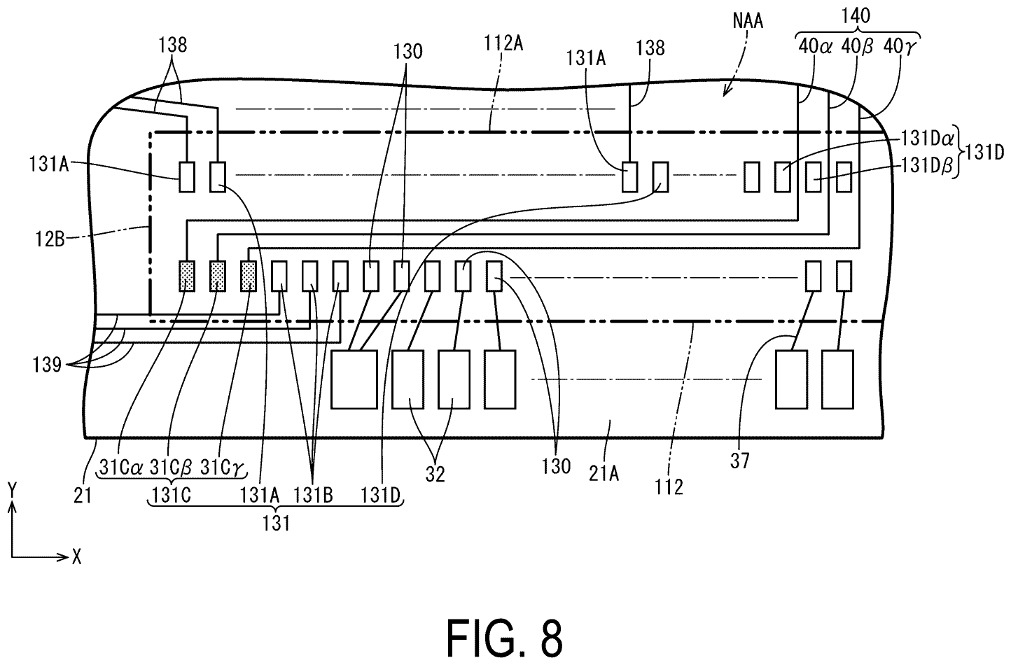

A second embodiment will be described with reference to FIG. 8. In the second embodiment, a case in which the disposition of switch control terminal portions 131C and the like are changed from the above-discussed first embodiment will be described. Further, repetitive descriptions of structures, actions, and effects similar to those of the first embodiment described above will be omitted.

As illustrated in FIG. 8, some of output terminal portions 131 according to the present embodiment are arranged to form the same row with input terminal portions 130. The detailed disposition of the output terminal portions 131 in a mounting region of a driver 112 will be described below. A plurality of signal terminal portions 131A and a plurality of dummy terminal portions 131D (including a first dummy terminal portion 131Dα and a second dummy terminal portion 131Dβ) included in the output terminal portions 131 are located closer to the display region AA than the input terminal portions 130 in the Y-axis direction and are arranged at positions close to a first side portion 112A of the driver 112. The plurality of signal terminal portions 131A include the signal terminal portions 131A arranged at the positions where the plurality of gate control terminal portions 31B and the plurality of switch control terminal portions 31C are arranged in the first embodiment (see FIG. 7), and include, for example, the signal terminal portion 131A located at the endmost position (left end in FIG. 8) in the X-axis direction in the non-display region NAA in the mounting region of the driver 112. On the other hand, a plurality of gate control terminal portions 131B and a plurality of the switch control terminal portions 131C included in the output terminal portion 131 are located farther from the display region AA in the Y-axis direction (second direction) than the signal terminal portions 131A and the dummy terminal portions 131D and are arranged side by side together with the input terminal portion 130 along the X-axis direction. The switch control terminal portion 131C is disposed at the endmost side (left side in FIG. 8) in the X-axis direction in the non-display region NAA in the mounting region of the driver 112. Three switch control terminal portions 131C are arranged side by side at intervals in the X-axis direction. The gate control terminal portions 131B are disposed to be located closer to the center side (right side in FIG. 8) in the X-axis direction in the non-display region NAA than the switch control terminal portion 131C. Three gate control terminal portions 131B are arranged side by side at intervals in the X-axis direction.

Three gate control wiring lines 139 to be connected to the three gate control terminal portions 131B extend from the gate control terminal portions 131B as connecting targets along the Y-axis direction toward a side opposite to the display region AA side (the lower side in FIG. 8), bend and extend along the X-axis direction toward an end side of the non-display region NAA and then bend and extend along the Y-axis direction toward the gate drive circuit 15 as the connecting target (see FIG. 4). Three switch control wiring lines 140 extend from the switch control terminal portions 131C as a connecting target along the Y-axis direction toward the display region AA side (upper side in FIG. 8), bend and extend along the X-axis direction toward the center side in the non-display region NAA (right side in FIG. 8) and then bend and extend along the Y-axis direction toward the display region AA side to cross a first side portion 112A of the driver 112. The three switch control wiring lines 140 bend after crossing the first side portion 112A of the driver 112, extend toward the end side (left side in FIG. 8) in the non-display region NAA along the X-axis direction, and are connected to the first end portion 16A of the switch circuit 16 (see FIG. 7). The switch control wiring lines 140 are each arranged to pass through between the dummy terminal portions 131D arranged side by side along the X-axis direction in the mounting region of the driver 112 in the extending process from the switch control terminal portions 131C to the first end portion 16A of the switch circuit 16.

As described above, since the switch control terminal portions 131C are arranged to be located on the opposite side to the display region AA side in the Y-axis direction with respect to the dummy terminal portions 131D and the signal terminal portions 131A, a disposition space for the switch control terminal portions 131C is not needed on the row of the dummy terminal portions 131D and the signal terminal portions 131A. As a result, the number of signal terminal portions 131A to be provided can be increased, which is suitable for achieving higher definition.

As discussed above, according to the present embodiment, there are included: the source wiring lines 27 (not illustrated in FIG. 8) arranged in the display region AA and extending along the second direction intersecting the first direction; the signal terminal portions 131A each provided at a position overlapping the driver 112 in the non-display region NAA and connected to the driver 112; and a signal connection wiring line 138 provided in the non-display region NAA, connected to the signal terminal portion 131A and the source wiring line 27, and configured to transmit a signal to be supplied to the source wiring line 27. The plurality of signal terminal portions 131A are arranged side by side at intervals in the first direction. The first dummy terminal portion 131Dα, the second dummy terminal portion 131Dβ, and the signal terminal portion 131A are arranged to form a row along the first direction. The switch control terminal portion 131C is arranged to be located on the opposite side to the display region AA side in the second direction with respect to the first dummy terminal portion 131Dα, the second dummy terminal portion 131Dβ, and the signal terminal portion 131A. The disposition space for the switch control terminal portions 131C is not needed on the row of the first dummy terminal portion 131Dα, the second dummy terminal portion 131Dβ, and the signal terminal portions 131A. As a result, the number of signal terminal portions 131A to be provided can be increased, which is suitable for achieving higher definition.

### Third Embodiment

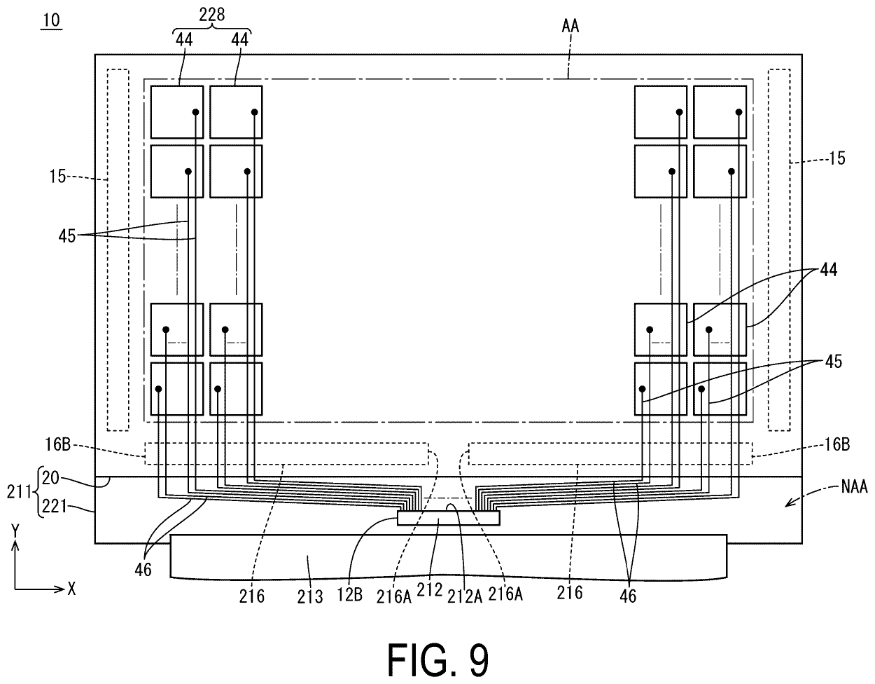

A third embodiment will be described with reference to FIGS. 9 to 11. In the third embodiment, a case where a touch panel function is added to a liquid crystal panel 211 will be described. Note that, repetitive descriptions of structures, actions, and effects similar to those of the first and second embodiments will be omitted.

As illustrated in FIG. 9, the liquid crystal panel 211 according to the present embodiment has, in addition to a display function for displaying an image, the touch panel function (position input function) for detecting a position of input by a user. In the liquid crystal panel 211, a touch panel pattern for exhibiting the touch panel function is integrated (in an in-cell form). The touch panel pattern is a so-called projected electrostatic capacitive type, and the detection type thereof is a self-capacitance type. The touch panel pattern is constituted by a plurality of touch electrodes (position detection electrodes) 44 arranged side by side in a matrix shape in a main surface of the liquid crystal panel 211. The touch electrodes 44 are arranged in the display region AA of the liquid crystal panel 211. Thus, the display region AA of the liquid crystal panel 211 substantially matches a touch region (position input region) in which an input position can be detected, and the non-display region NAA substantially matches a non-touch region (non-position input region) in which an input position cannot be detected. When a user brings his or her finger (position input object), which is a conductor, close to a surface (display surface) of the liquid crystal panel 211 to input a position based on an image in the display region AA of the liquid crystal panel 211 that is viewed by the user, electrostatic capacitance is formed between the finger and the touch electrode 44. Thus, the electrostatic capacitance detected by the touch electrode 44 near the finger changes in response to the approach of the finger and becomes different from that of the touch electrode 44 farther away from the finger, making it possible to detect the input position based on this. A specific number of touch electrodes 44 installed can be changed appropriately, in addition to the configuration depicted in FIG. 9. The touch electrode 44 has a substantially rectangular shape in a plan view, and one side thereof has a dimension of approximately several millimeters. Thus, the touch electrode 44 in a plan view is significantly larger than a pixel, which will be described later, in terms of size, and is disposed in a range overlapping a plurality of pixels in both the X-axis direction and the Y-axis direction.

As illustrated in FIG. 9, a plurality of touch wiring lines (position detection wiring lines) 45 provided in the liquid crystal panel 211 are selectively connected to the plurality of touch electrodes 44. The touch wiring line 45 extends along the Y-axis direction, and one end side thereof is connected to a specified touch electrode 44 among the plurality of touch electrodes 44 aligned along the Y-axis direction in the display region AA. The touch wiring line 45 is formed of part of a third metal film that is arranged on the upper-layer side with respect to an insulating film arranged on the upper-layer side of the second metal film. The touch wiring line 45 may be disposed overlapping the source wiring line 27 made of the second metal film. The third metal film, similar to the first and second metal films, is a single-layer film made of one type of metal material, or a layered film or alloy made of different types of metal materials, and thus has electrical conductivity. As a material of the third metal film, tantalum, molybdenum, titanium, or aluminum is used, for example. An insulating film made of an inorganic material or an organic material is interposed between the third metal film constituting the touch wiring line 45 and the first transparent electrode film constituting the touch electrode 44 (common electrode 228). In the insulating film, a contact hole for connecting the touch wiring line 45 to the touch electrode 44 is formed as an opening at a position where the touch wiring line 45 and the touch electrode 44 to be connected to each other overlap each other. The liquid crystal panel 211 is provided with a touch connection wiring line 46 connected to the other end side of the touch wiring line 45. The touch connection wiring line 46 is formed of part of the third metal film. One end side of the touch connection wiring line 46 is connected to the other end side of the touch wiring line 45, and the other end side thereof is connected to a driver 212 via a touch terminal portion 231E to be described later. Furthermore, the touch wiring line 45 is at least connected to a detection circuit via the touch connection wiring line 46. The detection circuit may be provided in the driver 212 or may be provided outside of the liquid crystal panel 211 via a flexible substrate 213.

As illustrated in FIG. 9, the touch electrodes 44 and the touch wiring lines 45 are all provided on an array substrate 221. Among them, the touch electrodes 44 are formed by dividing the common electrode 228 provided on the array substrate 221. To be specific, by providing lattice-shaped partition openings in the common electrode 228 arranged in a substantially solid state in a main surface of the array substrate 221, the plurality of touch electrodes 44 aligned in the X-axis direction and the Y-axis direction in a checkerboard-like shape are formed. A common potential signal related to the image display function and a touch signal (position detection signal) related to the touch panel function are supplied from the driver 212 to the touch wiring lines 45 connected to the touch electrodes 44 in a time-division manner. A timing when the common potential signal is supplied from the driver 212 to the touch wiring lines 45 is a display period, and a timing when the touch signal is supplied from the driver 212 to the touch wiring lines 45 is a sensing period (position detection period). The common potential signal is transmitted to all of the touch wiring lines 45 at the same timing (display period), and thus all of the touch electrodes 44 are set at a reference potential based on the common potential signal and function as the common electrode 228. The touch electrode 44 has the touch panel function and also functions as the above-described common electrode 228. During the display period, as described in paragraph 0032, the pixel electrode 25 is charged with a potential based on the image signal (see FIG. 4), and during this display period, the touch electrode 44 functions as the common electrode 228.

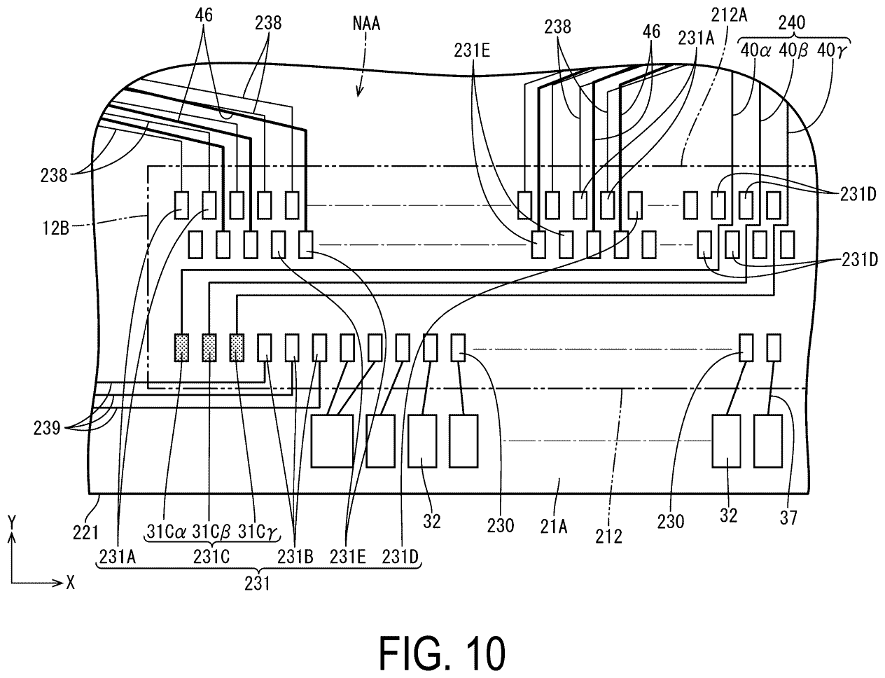

As illustrated in FIG. 10, a plurality of the touch terminal portions 231E to be connected to the touch connection wiring lines 46 are provided as an output terminal portion 231 in the mounting region of the driver 212 on the array substrate 221. Details of the output terminal portion 231 will be described below. A plurality of signal terminal portions 231A, a plurality of dummy terminal portions 231D, and a plurality of the touch terminal portions 231E included in the output terminal portion 231 form two rows spaced apart from each other in the Y-axis direction. The plurality of signal terminal portions 231A and the plurality of dummy terminal portions 231D are respectively arranged at intervals along the X-axis direction to form one row (hereinafter referred to as an “upper-side row”) and are arranged closer to the display region AA in the Y-axis direction than a row of the plurality of dummy terminal portions 231D and the plurality of touch terminal portions 231E to be described below. In the upper-side row, the plurality of signal terminal portions 231A are arranged on an end side (left side in FIG. 10) in the X-axis direction in the non-display region NAA in the mounting region of the driver 212 and are arranged side by side at intervals along the X-axis direction. In the upper-side row, the plurality of dummy terminal portions 231D are arranged on the center side (right side in FIG. 10) in the X-axis direction in the non-display region NAA in the mounting region of the driver 212 and are arranged side by side at intervals along the X-axis direction.

The plurality of dummy terminal portions 231D and the plurality of touch terminal portions 231E are arranged at intervals along the X-axis direction to form one row (hereinafter referred to as a “lower-side row”) and are arranged at the positions located on the opposite side to the display region AA side relative to the row of the plurality of signal terminal portions 231A and spaced apart from the row of the signal terminal portions 231A. In the lower-side row, the plurality of touch terminal portions 231E are arranged on the end side (left side in FIG. 10) in the X-axis direction in the non-display region NAA in the mounting region of the driver 212 and are arranged side by side at intervals along the X-axis direction. In the lower-side row, the plurality of dummy terminal portions 231D are arranged on the center side (right side in FIG. 10) in the X-axis direction in the non-display region NAA in the mounting region of the driver 212 and are arranged side by side at intervals along the X-axis direction. The positions of the plurality of signal terminal portions 231A and the plurality of dummy terminal portions 231D forming the upper-side row are displaced in the X-axis direction from those of the plurality of dummy terminal portions 231D and the plurality of touch terminal portions 231E forming the lower-side row. An amount of positional displacement in the X-axis direction between the plurality of signal terminal portions 231A and the plurality of dummy terminal portions 231D forming the upper-side row, and the plurality of dummy terminal portions 231D and the plurality of touch terminal portions 231E forming the lower-side row is approximately half an array pitch of the output terminal portion 231. As discussed above, the plurality of signal terminal portions 231A, the plurality of dummy terminal portions 231D, and the plurality of touch terminal portions 231E forming the two rows are disposed in a zig-zag shape as a whole.

As illustrated in FIG. 10, a plurality of gate control terminal portions 231B and a plurality of switch control terminal portions 231C included in the output terminal portion 231 are located farther from the display region AA in the Y-axis direction than the signal terminal portions 231A, the dummy terminal portions 231D and the touch terminal portions 231E, and are disposed side by side along the X-axis direction to form the same row with an input terminal portion 230. In FIG. 10, the switch control terminal portions 231C are depicted in a shaded manner in order to distinguish them from the other terminal portions 230, 231A, 231B, and 231D. The switch control terminal portions 231C are disposed at the endmost side (left side in FIG. 10) in the X-axis direction in the non-display region NAA in the mounting region of the driver 212. Three switch control terminal portions 231C are arranged side by side at intervals in the X-axis direction. The gate control terminal portions 231B are disposed to be located closer to the center side (right side in FIG. 10) in the X-axis direction in the non-display region NAA than the switch control terminal portions 231C. Three gate control terminal portions 231B are arranged side by side at intervals in the X-axis direction.

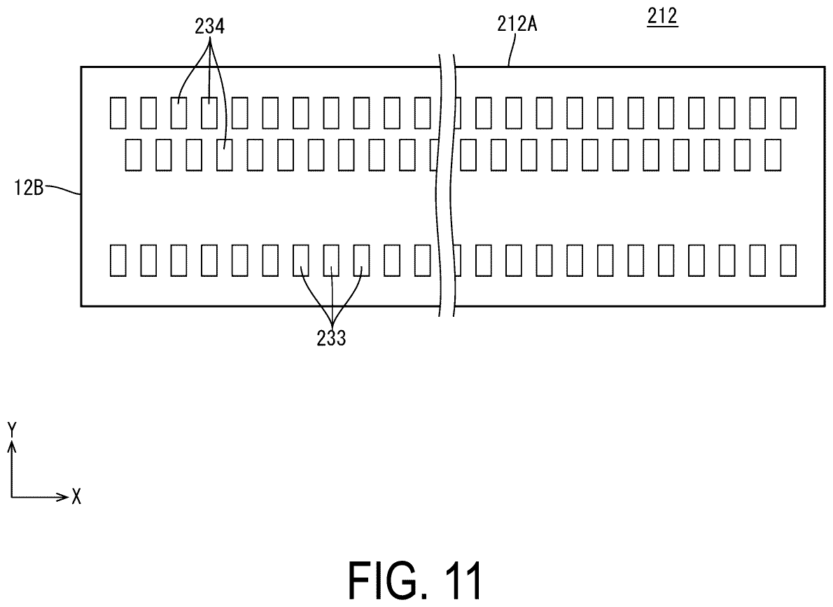

As illustrated in FIG. 11, a plurality of bumps 233 and 234 provided on a main surface of the driver 212 facing the array substrate 221 are arranged at positions overlapping the terminal portions 230 and 231 on the array substrate 221 side. Among the plurality of output bumps 234, the output bumps 234 overlapping the plurality of signal terminal portions 231A, the plurality of dummy terminal portions 231D, and the plurality of touch terminal portions 231E form two rows spaced apart from each other in the Y-axis direction and are disposed in a zig-zag shape. The plurality of input bumps 233 are arranged side by side at intervals along the X-axis direction to form one row at a position spaced apart in the Y-axis direction from the opposite side to a first side portion 212A side with respect to the plurality of output bumps 234 disposed in the zig-zag shape mentioned above. Among the plurality of output bumps 234, the output bumps 234 overlapping the plurality of gate control terminal portions 231B and the plurality of switch control terminal portions 231C are disposed side by side along the X-axis direction to form the same row as the plurality of input bumps 233.

As illustrated in FIG. 10, the plurality of touch connection wiring lines 46 connected to the plurality of touch terminal portions 231E extend from the touch terminal portions 231E as connecting targets toward the display region AA side (upper side in FIG. 10) along the Y-axis direction, pass through between two signal terminal portions 231A adjacent to each other in the X-axis direction, and cross the first side portion 212A of the driver 212. Then, the touch connection wiring lines 46 bend and extend toward the touch wiring lines 45 as connecting targets along a direction oblique to the X-axis direction and the Y-axis direction, in a similar manner to signal connection wiring lines 238. Since the touch connection wiring line 46 is formed of part of the third metal film, even in a case where the touch connection wiring line 46 intersects the signal connection wiring line 238 formed of the first metal film, the second metal film, or the like, the occurrence of a short circuit is prevented.

A plurality of switch control wiring lines 240 extend from the switch control terminal portions 231C as connecting targets along the Y-axis direction toward the display region AA side (upper side in FIG. 10), bend and extend along the X-axis direction toward the center side in the non-display region NAA (right side in FIG. 10) and then bend and extend along the Y-axis direction toward the display region AA side. The switch control wiring lines 240 bend in a crank shape so as to pass through between the plurality of dummy terminal portions 231D arranged in the zig-zag shape, and then cross the first side portion 212A of the driver 212. The switch control wiring lines 240 bend after crossing the first side portion 212A of the driver 212, extend toward the end side (left side in FIG. 10) in the non-display region NAA along the X-axis direction, and are connected to a first end portion 216A of a switch circuit 216. With the configuration discussed above, in a similar manner to the above-described second embodiment, the number of signal terminal portions 231A to be provided can be increased, which is suitable for achieving higher definition. The routing path of gate control wiring lines 239 is similar to that in the second embodiment.

### Fourth Embodiment

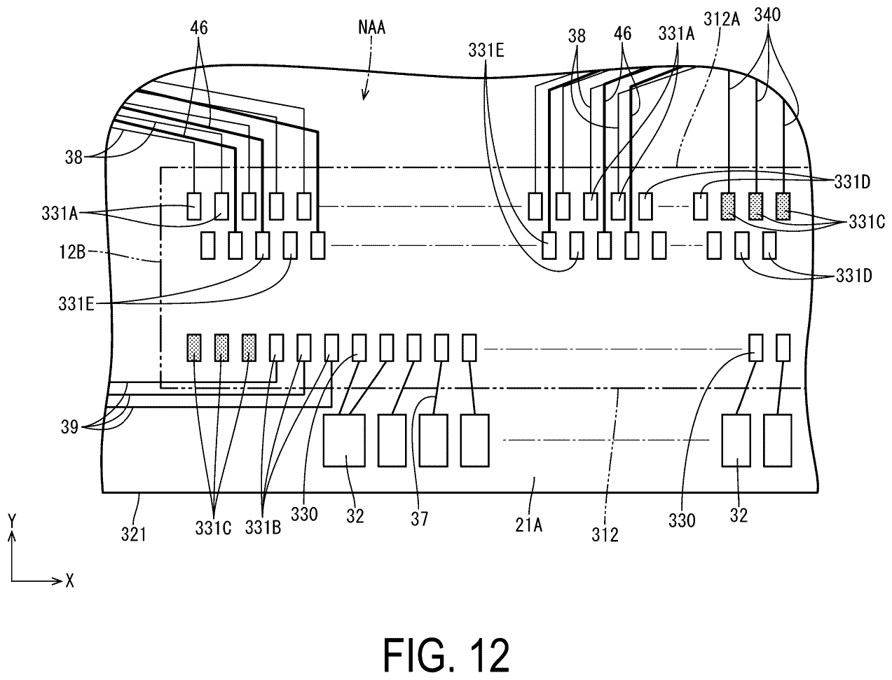

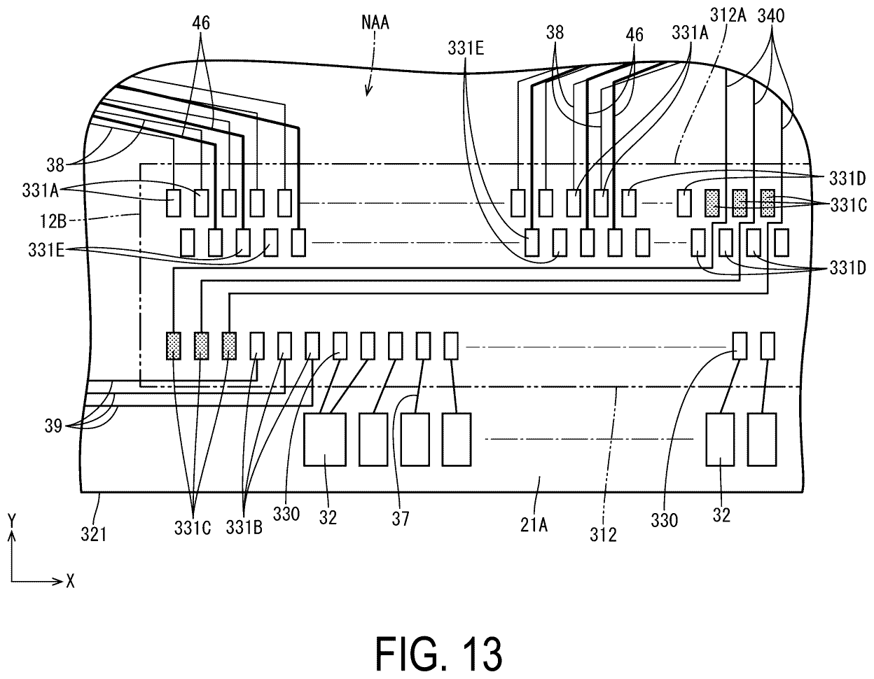

A fourth embodiment will be described with reference to FIG. 12 and FIG. 13. In the fourth embodiment, a case will be described in which the number of switch control terminal portions 331C to be provided and the like are changed from the third embodiment. Note that redundant descriptions of structures, actions, and effects similar to those of the third embodiment described above will be omitted.

As illustrated in FIGS. 12 and 13, two groups each including a plurality of the switch control terminal portions 331C are provided in the mounting region of a driver 312 according to the present embodiment. In FIGS. 12 and 13, the switch control terminal portions 331C are depicted in a shaded manner in order to distinguish them from other terminal portions 330, 331A, 331B, 331D, and 331E. The switch control terminal portions 331C constituting a first group form the same row with a plurality of the signal terminal portions 331A, where three switch control terminal portions 331C are arranged at intervals in the X-axis direction. That is, among the plurality of signal terminal portions 331A, a plurality of the dummy terminal portions 331D, and a plurality of the touch terminal portions 331E forming two rows, the three switch control terminal portions 331C constituting the first group form the upper-side row. The three switch control terminal portions 331C constituting the first group are arranged to be located closer to the display region AA side in the Y-axis direction (second direction) than the input terminal portion (third terminal portion) 330. The three switch control terminal portions 331C constituting the first group are arranged closer to the center side (right side in FIG. 12) in the X-axis direction than the dummy terminal portions 331D forming the upper-side row in the non-display region NAA. The switch control terminal portions 331C constituting a second group form the same row with the plurality of input terminal portions 330, where three switch control terminal portions 331C are arranged at intervals in the X-axis direction. The three switch control terminal portions 331C constituting the second group are disposed closer to the end side (left side in FIG. 12) in the X-axis direction in the non-display region NAA than the gate control terminal portions 331B and are located at the endmost side in the X-axis direction in the non-display region NAA in the mounting region of the driver 312.

In the present embodiment, as illustrated in FIGS. 12 and 13, switch control wiring lines 340 are selectively provided to be connected to either the switch control terminal portions 331C constituting the first group or the switch control terminal portions 331C constituting the second group. Specifically, for example, two types of drivers 312 with different dispositions of the output bumps 34 (see FIG. 11) configured to output switch signals may be selectively used as the driver 312 mounted on an array substrate 321. In this case, regardless of the specifications of the driver 312 mounted on the array substrate 321, either the switch control terminal portions 331C constituting the first group or the switch control terminal portions 331C constituting the second group are connected to the output bumps 34 configured to output the switch signals. Then, which of the switch control terminal portions 331C constituting the first group or the switch control terminal portions 331C constituting the second group the switch control wiring lines 340 should be connected to is determined in accordance with the specifications of the driver 312 mounted on the array substrate 321.

To be specific, when the output bumps 34 for outputting the switch signals of the driver 312 are connected to the switch control terminal portions 331C constituting the first group, the switch control wiring lines 340 are provided to be connected to the switch control terminal portions 331C constituting the first group, as illustrated in FIG. 12. In this case, the switch control wiring lines 340 extend toward the display region AA side along the Y-axis direction from the switch control terminal portions 331C as connecting targets and cross a first side portion 312A of the driver 312. When the output bumps 34 for outputting the switch signals of the driver 312 are connected to the switch control terminal portions 331C constituting the second group, the switch control wiring lines 340 are provided to be connected to the switch control terminal portions 331C constituting the second group, as illustrated in FIG. 13. In this case, the switch control wiring lines 340 extend from the switch control terminal portions 331C as connecting targets along the Y-axis direction toward the display region AA side (upper side in FIG. 13), bend and extend along the X-axis direction toward the center side in the non-display region NAA (right side in FIG. 13) and then bend and extend along the Y-axis direction toward the display region AA side. The switch control wiring lines 340 bend in a crank shape so as to pass through between the plurality of dummy terminal portions 331D arranged in the zig-zag shape and the switch control terminal portions 331C constituting the first group, and then cross the first side portion 312A of the driver 312.

As illustrated in FIG. 12, when the switch control wiring lines 340 are connected to the switch control terminal portions 331C constituting the first group, the wiring line length of the switch control wiring line 340 can be shortened as compared with a case of being connected to the switch control terminal portions 331C constituting the second group. As a result, the load on the switch control wiring lines 340 can be reduced. In the present embodiment, by providing the switch control terminal portions 331C of two groups on the array substrate 321, it is possible to selectively mount two types of drivers 312 with different configurations of the output bumps 34, thereby making it possible to enhance the versatility of the array substrate 321. Of the switch control terminal portions 331C of the two groups, the switch control terminal portions 331C of the group not connected to the output bumps 34 configured to output the switch signals are substantially electrically isolated in a similar manner to the dummy terminal portions 331D.

As discussed above, according to the present embodiment, there are included the input terminal portions (third terminal portions) 330 provided at the positions overlapping the driver 312 in the non-display region NAA, in which the switch control terminal portions 331C are arranged to be located on the display region AA side with respect to the input terminal portions 330 in the second direction intersecting the first direction. The wiring line length of the switch control wiring line 340 can be shortened as compared with a case where the switch control terminal portions 331C are arranged to form a row with the input terminal portions 330 along the first direction. As a result, the load on the switch control wiring lines 340 can be reduced.

### Fifth Embodiment

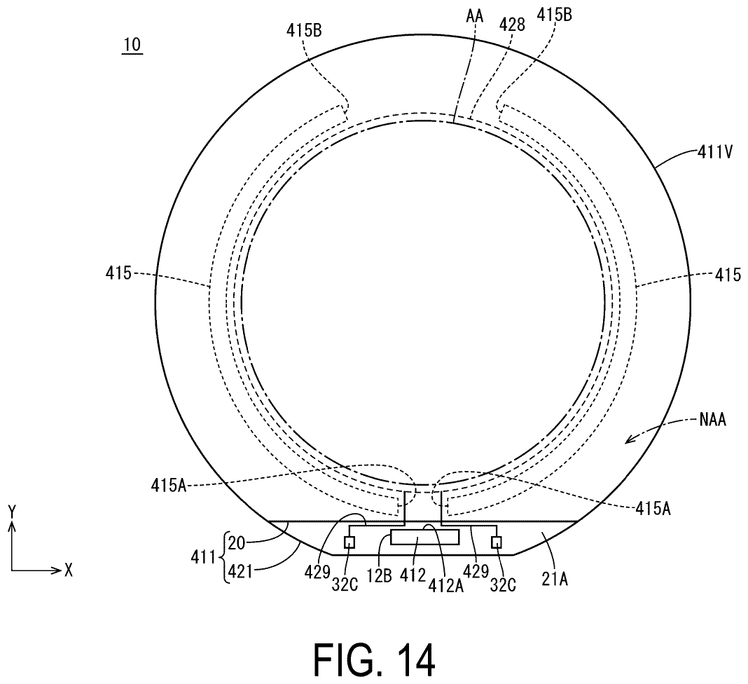

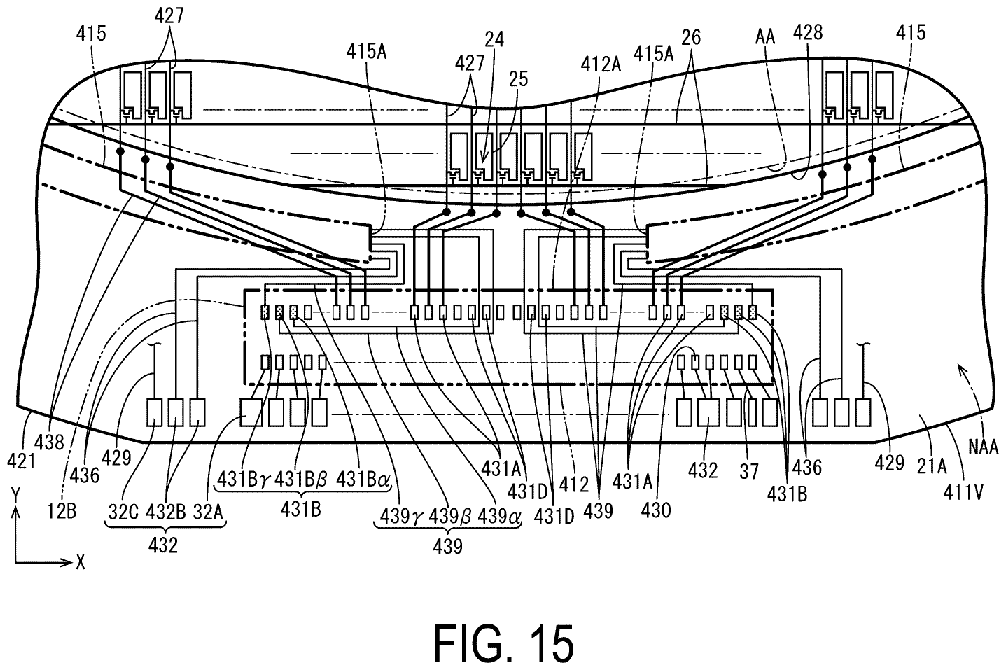

A fifth embodiment will be described with reference to FIGS. 14 and 15. In the fifth embodiment, a case will be described in which a planar shape of a liquid crystal panel 411 is changed from the planar shape in the first embodiment described above. Further, repetitive descriptions of structures, actions, and effects similar to those of the first embodiment described above will be omitted.

The liquid crystal panel 411 according to the present embodiment has a substantially circular planar shape as a whole, as illustrated in FIG. 14. Specifically, although part of the outer circumferential end portion of the liquid crystal panel 411 has a linear shape along the X-axis direction, most of the remaining portion has an arc shape. The arc-shaped portion of the outer circumferential end portion of the liquid crystal panel 411 constitutes a variable outer shape portion 411V, whose external dimension in the X-axis direction changes dependent on the position in the Y-axis direction. The display region AA in the liquid crystal panel 411 has a circular shape. The non-display region NAA in the liquid crystal panel 411 has a substantially annular shape surrounding the circular display region AA. A common electrode 428 provided on an array substrate 421 has a circular shape slightly larger than the display region AA, and a common wiring line 429 is connected to part of the outer circumferential end portion of the common electrode 428. A driver 412 and a flexible substrate 13 (not illustrated in any of FIG. 14 and FIG. 15) are mounted near the linear portion of the outer circumferential end portion of the liquid crystal panel 411.

A pair of gate drive circuits (first circuit portions) 415 is provided in such a manner as to sandwich the display region AA from both sides thereof in the X-axis direction as illustrated in FIG. 14. The gate drive circuit 415 is provided in a half-arc belt-shaped range extending along the outer shape of the variable outer shape portion 411V and extends from the center side toward the end side in the X-axis direction. The gate drive circuit 415 has a symmetrical shape with respect to a symmetry axis along the X-axis direction. One end portion of the gate drive circuit 415 is taken as a first end portion 415A located at a position close to the driver 412 with a space therebetween in the Y-axis direction and arranged to be located in the vicinity of the center portion of the non-display region NAA in the X-axis direction. The other end portion of the gate drive circuit 415 is taken as a second end portion 415B located at a position opposite to the driver 412 side in the Y-axis direction and arranged to be located in the vicinity of the center portion of the non-display region NAA in the X-axis direction. The gate drive circuit 415 is arranged such that the center portion thereof in the extending direction is located near the end portion of the non-display region NAA in the X-axis direction. The liquid crystal panel 411 according to the present embodiment is not provided with the switch circuit 16 (see FIG. 4) described in the first embodiment.

The dispositions of terminal portions 431A, 431B, and 431D in the mounting region of the driver 412 will be described below. As illustrated in FIG. 15, the gate control terminal portions (control terminal portions) 431B are disposed at the endmost side in the X-axis direction in the non-display region NAA in the mounting region of the driver 412. In FIG. 15, the gate control terminal portions 431B are shaded in order to distinguish them from other terminal portions 430, 431A, and 431D. Three gate control terminal portions 431B are arranged side by side at intervals in the X-axis direction. The driver 412 supplies a clock signal, an initialization signal, a gate start pulse signal, and the like to the gate control terminal portions 431B. The clock signal, the initialization signal, and the gate start pulse signal are all control signals for controlling the operations of the gate drive circuit 415. The signal terminal portions 431A are located closer to the center side of the non-display region NAA in the X-axis direction than the gate control terminal portions 431B. The number of signal terminal portions 431A is equal to the number of source wiring lines 427, and the signal terminal portions 431A are arranged side by side at intervals in the X-axis direction. The dummy terminal portions 431D are disposed at the center-most side in the X-axis direction of the non-display region NAA, in the mounting region of the driver 412. The number of dummy terminal portions 431D is obtained by subtracting the numbers of signal terminal portions 431A and gate control terminal portions 431B from the number of output bumps 34 of the driver 412 to be mounted, and the dummy terminal portions 431D are arranged side by side at intervals in the X-axis direction. The liquid crystal panel 411 according to the present embodiment is not provided with the switch circuit 16, as described above, and therefore the switch control terminal portion 31C described in the first embodiment (see FIG. 7) is not provided.

As illustrated in FIG. 15, a plurality of signal connection wiring lines 438 to be connected to the plurality of signal terminal portions 431A extend from the signal terminal portions 431A as connecting targets toward the display region AA side (upper side in FIG. 15) along the Y-axis direction, cross a first side portion 412A of the driver 412, bend and extend toward the source wiring lines 427 as connecting targets along a direction oblique to the X-axis direction and the Y-axis direction. The signal connection wiring lines 438 are directly connected to the source wiring lines 427. The plurality of signal connection wiring lines 438 include the signal connection wiring line 438 that intersects the gate drive circuit 415, a gate control wiring line (control wiring line) 439, and the like on the way extending from the signal terminal portion 431A to the source wiring line 427. The signal connection wiring line 438 is formed of the third metal film that is arranged on the upper-layer side with respect to an insulating film arranged on the upper-layer side of the second metal film. On the other hand, a wiring line and a circuit element constituting the gate drive circuit 415 are formed using the first metal film, the second metal film, a semiconductor film, and the like, but the third metal film is not used. Similarly, the gate control wiring line 439 is formed using the first metal film, the second metal film, and the like, but the third metal film is not used. Therefore, the signal connection wiring line 438 that intersects the gate drive circuit 415, the gate control wiring line 439, and the like is prevented from being short-circuited with the wiring line and circuit element constituting the gate drive circuit 415, the gate control wiring line 439, or the like. The third metal film, similar to the first and second metal films, is a single-layer film made of one type of metal material, or a layered film or alloy made of different types of metal materials, and thus has electrical conductivity. As a material of the third metal film, tantalum, molybdenum, titanium, or aluminum is used, for example. An insulating film made of an inorganic material is interposed between the third metal film constituting the signal connection wiring line 438 and the first transparent electrode film constituting the common electrode 428. The liquid crystal panel 411 according to the present embodiment is not provided with the switch control terminal portion 31C, as described above, and therefore the switch control wiring line 40 described in the first embodiment (see FIG. 7) is not provided.

As illustrated in FIG. 15, three gate control wiring lines 439 are arranged to take two paths extending from the respective gate control terminal portions 431B to the first end portion 415A of the gate drive circuit 415. The three gate control wiring lines 439 include a first gate control wiring line (first control wiring line) 439α and a second gate control wiring line (second control wiring line) 439B, which take a first path extending from each of the gate control terminal portions 431B to the first end portion 415A of the gate drive circuit 415, and a third gate control wiring line (third control wiring line) 439γ, which takes a second path extending from each of the gate control terminal portions 431B to the first end portion 415A of the gate drive circuit 415. The three gate control terminal portions 431B include a first gate control terminal portion (first control terminal portion) 431Bα connected to the first gate control wiring line 439α, a second gate control terminal portion (second control terminal portion) 431Bβ connected to the second gate control wiring line 439β, and a third gate control terminal portion (third control terminal portion) 431Bγ connected to the third gate control wiring line 439Y.

As illustrated in FIG. 15, the first gate control wiring line 439α and the second gate control wiring line 439β respectively extend from the gate control terminal portions 431Bα and 431Bβ as connecting targets toward the opposite side to the display region AA side (lower side in FIG. 15) along the Y-axis direction, bend and extend toward the center side in the non-display region NAA along the X-axis direction and then bend and extend along the Y-axis direction toward the display region AA side so as to cross the first side portion 412A of the driver 412. The first gate control wiring line 439α and the second gate control wiring line 439β bend after crossing the first side portion 412A of the driver 412, extend toward the end side in the non-display region NAA along the X-axis direction, and are connected to the first end portion 415A of the gate drive circuit 415. The first gate control wiring line 439α and the second gate control wiring line 439β are each arranged to pass through between the dummy terminal portions 431D aligned along the X-axis direction in the mounting region of the driver 412 in the extending process from the gate control terminal portions 431Bα and 431Bβ as connecting targets to the first end portion 415A of the gate drive circuit 415. As described above, the first path in which the first gate control wiring line 439α and the second gate control wiring line 439β extend from the gate control terminal portions 431Bα and 431Bβ as the connecting targets, to the first end portion 415A of the gate drive circuit 415 is substantially similar to the path of each switch control wiring line 40 described in the first embodiment. Therefore, according to the present embodiment, in a similar manner to the above-described first embodiment, it is possible to lessen the load on the gate control wiring line 439, and to achieve the effect of narrowing the frame.

As illustrated in FIG. 15, the third gate control wiring line 439γ extends from the third gate control terminal portion 431Bγ toward the display region AA side (upper side in FIG. 15) along the Y-axis direction, bends after crossing the first side portion 412A of the driver 412 and extends toward the center side in the non-display region NAA along the X-axis direction. The third gate control wiring line 439γ bends again to extend toward the display region AA side along the Y-axis direction, bends to extend toward the end side in the non-display region NAA along the X-axis direction and is connected to the first end portion 415A of the gate drive circuit 415. A power source wiring line 436 bends when it extends from a power supply terminal portion 432B included in a terminal portion 432 for a flexible substrate toward the display region AA side along the Y-axis direction, extends toward the center side in the non-display region NAA along the X-axis direction, and then extends following the third gate control wiring line 439γ so as to be connected to the first end portion 415A of the gate drive circuit 415.

As described above, according to the present embodiment, the liquid crystal panel 411 includes the variable outer shape portion 411V, whose external dimension in the first direction changes depending on the position in the second direction intersecting the first direction, and the gate drive circuit (first circuit portion) 415 extends following the outer shape of the variable outer shape portion 411V. In the non-display region NAA of the liquid crystal panel 411, it is difficult to sufficiently secure a space for disposing the wiring lines or the like between the outer end forming the outer shape of the variable outer shape portion 411V and the gate drive circuit 415. In this regard, since the gate control wiring line (control wiring line) 439 is arranged to extend from the gate control terminal portion (control terminal portion) 431B to the first end portion 415A of the gate drive circuit 415 across the first side portion 412A, it is unnecessary to secure a disposition space for the gate control wiring line 439 between the outer end of the variable outer shape portion 411V and the gate drive circuit 415. Thus, the frame can be narrowed, which is suitable for downsizing the liquid crystal panel 411.

### Other Embodiments

The techniques disclosed herein are not limited to the embodiments described above and illustrated in the drawings, and the following embodiments, for example, are also included within the technical scope.

(1) In the configurations described in the first to fourth embodiments, a specific path in which a switch control wiring lines 40, 140, 240, and 340 extend from the switch control terminal portions 31C, 131C, 231C, and 331C to the first end portion 16A and 216A of the switch circuit 16 and 216 can be appropriately changed to a path other than the illustrated path. For example, there may be a path in which the switch control wiring lines 40, 140, 240, and 340 each passes through between two signal terminal portions 31A, 131A, 231A, and 331A adjacent to each other respectively in the X-axis direction.

(2) In the configurations described in the first and second embodiments, the specific dispositions of and the specific numbers of pieces of the signal terminal portions 31A and 131A, the gate control terminal portions 31B and 131B, the switch control terminal portions 31C and 131C, and the dummy terminal portions 31D and 131D can be appropriately changed from the illustrated configurations. When the number of pieces of the switch control terminal portions 31C and 131C is changed, the number of pieces of the switch control wiring lines 40 and 140 is also changed accordingly.

(3) In the configurations described in the third and fourth embodiments, the specific dispositions of and the specific numbers of pieces of the signal terminal portions 231A and 331A, the gate control terminal portions 231B and 331B, the switch control terminal portions 231C and 331C, the dummy terminal portions 231D and 331D, and the touch terminal portions 231E and 331E can be appropriately changed from the illustrated configurations. For example, the touch terminal portions 231E and 331E may be provided in a row (upper-side row) close to the display region AA, and the signal terminal portions 231A and 331A may be provided in a row (lower-side row) far from the display region AA. The touch terminal portions 231E and 331E and the signal terminal portions 231A and 331A may be provided in the same row. In a case of being provided in the same row, a terminal group of the touch terminal portions 231E and 331E and a terminal group of the signal terminal portions 231A and 331A may be provided on the same row, or the touch terminal portions 231E and 331E and the signal terminal portions 231A and 331A may be provided on the same row while being mixed and adjacent to each other.

(4) In the configuration described in the fifth embodiment, the specific path in which the gate control wiring line 439 extends from the gate control terminal portion 431B to the first end portion 415A of the gate drive circuit 415 can be appropriately changed to a path other than the illustrated path. For example, there may be a path in which the gate control wiring line 439 passes through between two signal terminal portions 431A adjacent to each other in the X-axis direction. When the number of pieces of the gate control terminal portions 431B is changed, the number of pieces of the gate control wiring lines 439 is also changed accordingly.

(5) In the configurations described in the fifth embodiment, the specific dispositions of and the specific numbers of pieces of the signal terminal portions 431A, the gate control terminal portions 431B, and the dummy terminal portions 431D can be appropriately changed from the illustrated configurations.

(6) In the configuration described in the fifth embodiment, the outer shape of the liquid crystal panel 411 in a plan view may be, for example, a substantially elliptical shape, a substantially oval shape, a substantially trapezoidal shape, or a substantially rhombic shape, in addition to the substantially circular shape.

(7) A plurality of the drivers 12, 112, 212, 312, and 412 may be provided on the array substrates 21, 221, 321, and 421.

(8) The dummy terminal portions 31D, 131D, 231D, 331D, and 431D may be allowed not to be provided.

(9) The number of colors of the color filters may be equal to or less than two, or equal to or more than four. When it is intended to increase the number of colors of the color filters, a yellow color filter configured to exhibit yellow, a transparent color filter configured to transmit light of the full wavelength region, or the like can be added.

(10) It is also possible to provide the gate drive circuit 15 at only one side portion of the pair of side portions in the X-axis direction of the array substrates 21, 121, 221, 321, and 421.

(11) In the configurations described in the first to fourth embodiments, the gate drive circuit 15 may be omitted. In this case, a gate driver having the same function as that of the gate drive circuit 15 may be mounted on the array substrates 21, 121, 221, 321, and 421.

(12) In the configuration described in the fifth embodiment, the switch circuit 16, 216 may be provided. In this case, the switch control terminal portions 31C, 131C, 231C, and 331C and the switch control wiring lines 40, 140, 240, and 340 are also provided.

(13) In the configurations described in the third and fourth embodiments, the touch panel pattern may be a mutual-capacitance type in addition to a self-capacitance type.

(14) In the configurations described in the third and fourth embodiments, the liquid crystal panel 211 may be allowed not to include the touch panel pattern (touch panel function). In this case, the common electrode 228 has a non-divided structure, the touch electrode 44 is not formed, and the touch wiring line 45 is not formed.

(15) In the configurations described in the third and fourth embodiments, the touch wiring lines 45 may be arranged not to overlap the source wiring lines 27 (not illustrated in FIGS. 9 to 13).

(16) The pixel electrode 25 may be formed of the second transparent electrode film, and the common electrode 28 (the touch electrode 44 in the third and fourth embodiments) may be formed of the first transparent electrode film. In this case, it is preferable to form a slit for alignment control in the pixel electrode 25.

(17) The display mode of the liquid crystal panels 11, 211, and 411 may be a Twisted Nematic (TN) mode, a Vertical Alignment (VA) mode, an In-Plane Switching (IPS) mode, or the like in addition to the FFS mode.

(18) The liquid crystal panels 11, 211, and 411 may be a reflective type or a transflective type, in addition to a transmissive type.

(19) In addition to the liquid crystal display device 10 including the liquid crystal panels 11, 211, and 411, an organic electro luminescence (EL) display device including an organic EL display panel may be used.

(20) In each of the first to fifth embodiments, the terminal portions 30, 31, 130, 131, 230, 231, 330, and 331A to 331E, 430, 431A, 431B, and 431D provided in a loading region (mounting region) of the driver 12, 112, 212, 312, and 412 and the wiring lines 37, 38, 39, 40, 138, 139, 140, 238, 239, 240, 340, 438, and 439 connected to the terminal portions 30, 31, 130, 131, 230, 231, 330, and 331A to 331E, 430, 431A, 431B, and 431D are disposed symmetrically with respect to the Y-axis direction, but the disposition is not limited thereto. The positions of and the number of pieces of the terminal portions 30, 31, 130, 131, 230, 231, 330, and 331A to 331E, 430, 431A, 431B, and 431D may be asymmetric, and the number of pieces of and the paths of the wiring lines 37, 38, 39, 40, 138, 139, 140, 238, 239, 240, 340, 438, and 439 may be asymmetric. The terminal portions 30, 31, 130, 131, 230, 231, 330, and 331A to 331E, 430, 431A, 431B, and 431D do not need to have the same shape or dimension, and the shape or dimension thereof may be set in accordance with the type of signal, for example.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A display device comprising:
a display panel including a main surface including a display region in which an image is displayed and a non-display region surrounding the display region;
a driver attached to the non-display region;
a control terminal portion provided at a position overlapping the driver in the non-display region and connected to the driver;
a first circuit portion arranged to be interposed between the display region and the driver in the non-display region; and
a control wiring line provided in the non-display region, connected to each of the control terminal portion and the first circuit portion, and configured to transmit a control signal for controlling operations of the first circuit portion,
wherein a planar shape of the driver takes a rectangular shape, and a side portion closest to the display region of an outer peripheral portion of the driver is taken as a first side portion,
the first circuit portion extends from a center side toward an end side in a first direction along the first side portion in the non-display region, and includes at least a first end portion located at the center side in the first direction in the non-display region, and
the control wiring line is arranged extending from the control terminal portion to the first end portion of the first circuit portion across the first side portion.

2. The display device according to claim 1, further comprising:
a first terminal portion provided at a position overlapping the driver in the non-display region; and
a second terminal portion provided at a position overlapping the driver in the non-display region,
wherein the first terminal portion is arranged closer to the center side in the first direction than the control terminal portion in the non-display region,
the second terminal portion is arranged being distanced from the first terminal portion with a space on the center side of the first terminal portion in the first direction in the non-display region, and
the control wiring line is arranged in such a manner as to pass through between the first terminal portion and the second terminal portion and cross the first side portion.

3. The display device according to claim 2, further comprising:
a signal wiring line arranged in the display region and extending in a second direction intersecting the first direction;
a signal terminal portion provided at a position overlapping the driver in the non-display region and connected to the driver; and
a signal connection wiring line provided in the non-display region, connected to the signal terminal portion and the signal wiring line, and configured to transmit a signal to be supplied to the signal wiring line,
wherein the signal terminal portion is located between the control terminal portion and the first terminal portion in the first direction, and a plurality of the signal terminal portions are arranged side by side at intervals in the first direction.

4. The display device according to claim 2, further comprising:
a signal wiring line arranged in the display region and extending in a second direction intersecting the first direction;
a signal terminal portion provided at a position overlapping the driver in the non-display region and connected to the driver; and
a signal connection wiring line provided in the non-display region, connected to the signal terminal portion and the signal wiring line, and configured to transmit a signal to be supplied to the signal wiring line,
wherein a plurality of the signal terminal portions are arranged side by side at intervals in the first direction,
the first terminal portion, the second terminal portion, and the signal terminal portion are arranged in a row along the first direction, and
the control terminal portion is arranged to be located on an opposite side to a display region side in the second direction with respect to the first terminal portion, the second terminal portion, and the signal terminal portion.

5. The display device according to claim 2,
wherein both the first terminal portion and the second terminal portion are dummy terminal portions that are electrically isolated.

6. The display device according to claim 1, further comprising:
a third terminal portion provided at a position overlapping the driver in the non-display region,
wherein the control terminal portion is arranged to be located on a display region side with respect to the third terminal portion in a second direction intersecting the first direction.

7. The display device according to claim 1, further comprising:
a first signal wiring line arranged in the display region and extending along a second direction intersecting the first direction;
a second signal wiring line arranged in the display region and extending along the second direction; and
a signal connection wiring line arranged in the non-display region and configured to transmit a signal to be supplied to a plurality of the signal wiring lines,
wherein the control terminal portion includes a first control terminal portion and a second control terminal portion,
the control wiring line includes a first control wiring line connected to the first control terminal portion, and a second control wiring line connected to the second control terminal portion, and
the first circuit portion includes a first switching element connected to the first signal wiring line, the signal connection wiring line, and the first control wiring line, and a second switching element connected to the second signal wiring line, the signal connection wiring line, and the second control wiring line.

8. The display device according to claim 1,
wherein the display panel includes a variable outer shape portion whose external dimension in the first direction changes depending on a position in a second direction intersecting the first direction, and
the first circuit portion extends following an outer shape of the variable outer shape portion.
